(19) United States
(12) Patent Application Publication
(10) Pub. No.: US 2025/0388729 A1
(43) Pub. Date: Dec. 25, 2025

(54) METHODS OF REDUCING FILM THICKNESS VARIATION OF BIMODAL HDPE RESINS USING PEROXIDE TREATMENT

(71) Applicant: Chevron Phillips Chemical Company LP, The Woodlands, TX (US)

(72) Inventors: Eungkyu Kim, Bartlesville, OK (US); Jinping J. Zhou, Bartlesville, OK (US); Cory D. Pullins, Bartlesville, OK (US); Todd A. Robinson, Bartlesville, OK (US)

(21) Appl. No.: 19/241,492

(22) Filed: Jun. 18, 2025

Related U.S. Application Data
(60) Provisional application No. 63/661,943, filed on Jun. 20, 2024.

(51) Int. Cl. C08J 5/18; C08F 10/02; C08J 3/20; C08K 5/14

(52) U.S. Cl. CPC C08J 5/18; C08F 10/02; C08J 3/201; C08K 5/14; C08J 2323/08

(57) ABSTRACT

Ethylene-based polymers having a high load melt index of 4-15 g/10 min and a density of 0.94-0.96 g/cm³ are disclosed. These polymers can have one or more of a zero-shear viscosity from 475 to 2000 kPa-s, a relaxation time from 4 to 20 sec, a CY-a parameter from 0.2 to 0.28, a tan δ at 0.1 sec⁻¹ from 1 to 1.5 degrees, and/or from 3 to 10 long chain branches per 1,000,000 total carbon atoms. The ethylene polymers have improved/reduced film thickness variation and are produced by a method that includes a step of melt processing a mixture of a base polymer and a peroxide compound through a die to produce the ethylene polymer. The amount of the peroxide compound is from 1 to 10 ppm by weight of peroxide groups based on the weight of the base polymer (or the ethylene polymer).

### REFERENCE TO RELATED APPLICATION

This application claims the benefit of U.S. Provisional Patent Application No. 63/661,943, filed on Jun. 20, 2024, the disclosure of which is incorporated herein by reference in its entirety.

### TECHNICAL FIELD

The present disclosure generally relates to the use of low amounts of peroxide treatment to reduce blown film thickness variation, and more particularly, to HMW HDPE resins having excellent melt strength, tear resistance and impact strength, and surprising low gel content, which can be utilized in a variety of thin gauge film and related end-use applications.

### BACKGROUND

Polyolefins such as high density polyethylene (HDPE) homopolymer and copolymer and linear low density polyethylene (LLDPE) copolymer can be produced using various combinations of catalyst systems and polymerization processes for thin-gauge blown film applications. However, blown films produced from traditional Ziegler-Natta based HMW HDPE resins often have unacceptable film thickness variation. Thus, there is a need for improved HMW HDPE resins which will reduce the film thickness variation, but without sacrificing other desirable polymer and film attributes. Accordingly, it is to these ends that the present invention is generally directed.

### SUMMARY

This summary is provided to introduce a selection of concepts in a simplified form that are further described herein. This summary is not intended to identify required or essential features of the claimed subject matter. Nor is this summary intended to be used to limit the scope of the claimed subject matter.

Aspects of this invention are directed to high molecular weight and high density ethylene-based polymers (e.g., HMW HDPE). In one aspect, for instance, the ethylene polymer can have (or can be characterized by) a high load melt index (HLMI) in a range from 4 to 15 g/10 min, a density in a range from 0.94 to 0.96 g/cm³, and a zero-shear viscosity (η₀) in a range from 475 to 2000 kPa-s. In another aspect, the ethylene polymer can have (or can be characterized by) a high load melt index (HLMI) in a range from 4 to 15 g/10 min, a density in a range from 0.94 to 0.96 g/cm³, and a relaxation time (Tau(eta) or τ(η)) in a range from 4 to 20 sec. In another aspect, the ethylene polymer can have (or can be characterized by) a high load melt index (HLMI) in a range from 4 to 15 g/10 min, a density in a range from 0.94 to 0.96 g/cm³, and a CY-a parameter in a range from 0.2 to 0.28. In yet another aspect, the ethylene polymer can have (or can be characterized by) a high load melt index (HLMI) in a range from 4 to 15 g/10 min, a density in a range from 0.94 to 0.96 g/cm³, and a tan δ at 0.1 sec⁻¹ in a range from 1 to 1.5 degrees. In still another aspect, the ethylene polymer can have (or can be characterized by) a high load melt index (HLMI) in a range from 4 to 15 g/10 min, a density in a range from 0.94 to 0.96 g/cm³, and from 3 to 10 long chain branches (LCBs) per 1,000,000 total carbon atoms. These ethylene polymers can be used to produce various articles of manufacture, such as high stiffness films having improved/reduced film thickness variation.

For example, the ethylene polymer can have (or can be characterized by) a high load melt index (HLMI) in a range from 4 to 15 g/10 min, a density in a range from 0.94 to 0.96 g/cm³, and at least one of a CY-a parameter in a range from 0.2 to 0.28, and/or a tan δ at 0.1 sec⁻¹ in a range from 1 to 1.5 degrees, and/or from 3 to 10 long chain branches (LCBs) per 1,000,000 total carbon atoms. The ethylene polymer, in some aspects, can have (or can be characterized by) all of the CY-a parameter in a range from 0.2 to 0.28, and the tan δ at 0.1 sec⁻¹ in a range from 1 to 1.5 degrees, and from 3 to 10 long chain branches (LCBs) per 1,000,000 total carbon atoms. Additionally, the ethylene polymer can be further characterized by a zero-shear viscosity (η₀) in a range from 475 to 2000 kPa-s and/or a relaxation time (Tau(eta) or τ(η)) in a range from 4 to 20 sec.

Also encompassed herein are methods for method for making an ethylene polymer with reduced film thickness variation. A representative method can comprise melt processing a mixture (or blend) of a base polymer (or base resin) and a peroxide compound through a die to produce the ethylene polymer. The amount of the peroxide compound can range from 1 to 10 ppm by weight of peroxide groups based on the weight of the base polymer (or based on the weight of the ethylene polymer). Beneficially, the film thickness variation of a blown film produced from the ethylene polymer is less than that of the base polymer.

A related method provided herein is directed to a method for reducing film thickness variation of a film. This method can comprise (i) melt processing a mixture (or blend) of a base polymer (or base resin) and a peroxide compound through a die to produce an ethylene polymer, and (ii) melt processing the ethylene polymer through a film die to produce the film. The amount of the peroxide compound is from 1 to 10 ppm by weight of peroxide groups based on the weight of the base polymer (or based on the weight of the ethylene polymer). The film thickness variation of the film produced from the ethylene polymer is less than that of the base polymer, under the same film processing conditions.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the polymer compositions and/or methods described herein are contemplated with or without explicit description of the particular combination. Additionally, unless explicitly recited otherwise, any aspect and/or feature disclosed herein can be combined to describe inventive features consistent with the present disclosure.

Generally, groups of elements are indicated using the numbering scheme indicated in the version of the periodic table of elements published in Chemical and Engineering News, 63 (5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The terms “a,” “an,” and “the” are intended to include plural alternatives, e.g., at least one, unless otherwise specified.

The terms “contacting” and “combining” are used herein to describe compositions and processes/methods in which the materials are contacted or combined together in any order, in any manner, and for any length of time, unless otherwise specified. For example, the materials can be blended, mixed, slurried, dissolved, reacted, treated, processed, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The term “polymer” is used herein generically to include olefin homopolymers, copolymers, terpolymers, and the like, as well as alloys and blends thereof. The term “polymer” also includes impact, block, graft, random, and alternating copolymers. A copolymer is derived from an olefin monomer and one olefin comonomer, while a terpolymer is derived from an olefin monomer and two olefin comonomers. Accordingly, “polymer” encompasses copolymers and terpolymers derived from any olefin monomer and comonomer(s) disclosed herein. Similarly, the scope of the term “polymerization” includes homopolymerization, copolymerization, and terpolymerization. Therefore, an ethylene polymer includes ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, unless stated otherwise, and such configurations can include isotactic, syndiotactic, and random symmetries. Moreover, unless stated otherwise, the term “polymer” also is meant to include all molecular weight polymers and is inclusive of lower molecular weight polymers.

The terms “catalyst composition,” “catalyst mixture,” “catalyst system,” and the like, do not depend upon the actual product or composition resulting from the contact or reaction of the initial components of the disclosed or claimed catalyst composition (or catalyst system), the nature of the active catalytic site, or the fate of the co-catalyst or the titanium and/or magnesium compound, after combining these components. Therefore, the terms “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, can be used interchangeably throughout this disclosure.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the ethylene polymer can have various ratios of Mw/Mn in aspects of this invention. By a disclosure that the ratio of Mw/Mn is in a range from 20 to 40, the intent is to recite that the ratio of Mw/Mn can be any ratio in the range and, for example, can include any range or combination of ranges from 20 to 40, such as from 20 to 38, from 20 to 35, from 20 to 32, from 22 to 40, from 22 to 36, from 22 to 32, from 24 to 40, from 24 to 38, from 24 to 34, from 26 to 38, from 26 to 36, or from 26 to 34, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION

The present disclosure is generally directed to HMW HDPE resins having reduced blown film thickness variation, and to the methods for producing these HMW HDPE resins using low amounts of peroxide treatment.

An objective, therefore, of this invention is to produce ethylene-based polymers that reduce the film thickness variation during blown film processing. A further objective is to produce ethylene-based polymers that reduce the film thickness variation during blown film processing in combination with the ethylene-based polymer having excellent melt strength, tear resistance, impact strength, and tensile properties.

It was unexpectedly found that treating particular HMW HDPE base resins with low amounts of peroxide could not only reduce the film thickness variation of the resultant ethylene-based polymer during blown film processing, but that the resultant ethylene-based polymer had a unique combination of rheological, molecular weight, and branching properties. Further, the resultant ethylene-based polymer had excellent melt strength, tear resistance, impact strength, and tensile properties. As described herein, peroxide treatment surprisingly did not significantly reduce important film properties such as dart impact strength and Elmendorf tear strength.

Another objective of this invention is to reduce film thickness variation while maintaining acceptable film impact strength and tear resistance properties, and concurrently with maintaining a surprisingly low gel content, particularly given the use of peroxide treatment.

It is believed that ethylene-based polymers produced using low levels of peroxide treatment and having a high load melt index (HLMI) in a range from 4 to 15 g/10 min and a density in a range from 0.94 to 0.96 g/cm³, in combination with one or more of the following polymer attributes-a zero-shear viscosity in a range from 475 to 2000 kPa-s, a relaxation time in a range from 4 to 20 sec, a CY-a parameter in a range from 0.2 to 0.28, a tan δ at 0.1 sec⁻¹ in a range from 1 to 1.5 degrees, and/or from 3 to 10 long chain branches (LCBs) per 1,000,000 total carbon atoms-meet these objectives and also provide additional benefits that are disclosed herein.

### Ethylene Polymers

Generally, the polymers disclosed herein are ethylene-based polymers, or ethylene polymers, encompassing homopolymers of ethylene as well as copolymers, terpolymers, etc., of ethylene and at least one olefin comonomer. Comonomers that can be copolymerized with ethylene often can have from 3 to 20 carbon atoms in their molecular chain. For example, typical comonomers can include, but are not limited to, propylene, 1-butene, 1-pentene, 1-hexene, 1-heptene, 1-octene, and the like, or combinations thereof. In an aspect, the olefin comonomer can comprise a C₃-C₁₈ olefin; alternatively, the olefin comonomer can comprise a C₃-C₁₀ olefin; alternatively, the olefin comonomer can comprise a C₄-C₁₀ olefin; alternatively, the olefin comonomer can comprise a C₃-C₁₀ α-olefin; alternatively, the olefin comonomer can comprise a C₄-C₁₀ α-olefin; alternatively, the olefin comonomer can comprise 1-butene, 1-hexene, 1-octene, or any combination thereof; or alternatively, the comonomer can comprise 1-hexene. Typically, the amount of the comonomer, based on the total weight of monomer (ethylene) and comonomer, can be in a range from 0.01 to 20 wt. %, from 0.01 to 1 wt. %, from 0.5 to 15 wt. %, from 0.5 to 2 wt. %, or from 1 to 15 wt. %.

In one aspect, the ethylene polymer of this invention can comprise an ethylene/α-olefin copolymer, while in another aspect, the ethylene polymer can comprise an ethylene homopolymer, and in yet another aspect, the ethylene polymer of this invention can comprise an ethylene/α-olefin copolymer and an ethylene homopolymer. For example, the ethylene polymer can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer.

An illustrative and non-limiting example of a first ethylene polymer (e.g., comprising an ethylene copolymer) consistent with the present invention can have (or can be characterized by) a high load melt index (HLMI) in a range from 4 to 15 g/10 min, a density in a range from 0.94 to 0.96 g/cm³, and a zero-shear viscosity (η₀) in a range from 475 to 2000 kPa-s.

An illustrative and non-limiting example of a second ethylene polymer consistent with the present invention can have (or can be characterized by) a high load melt index (HLMI) in a range from 4 to 15 g/10 min, a density in a range from 0.94 to 0.96 g/cm³, and a relaxation time (Tau(eta) or τ(η)) in a range from 4 to 20 sec.

An illustrative and non-limiting example of a third ethylene polymer consistent with the present invention can have (or can be characterized by) a high load melt index (HLMI) in a range from 4 to 15 g/10 min, a density in a range from 0.94 to 0.96 g/cm³, and a CY-a parameter in a range from 0.2 to 0.28. Within a given catalyst type, lower CY-a values have been observed to be associated with higher levels of long chain branching (LCB), and a lower CY-a also can result from less of a high molecular weight tail.

An illustrative and non-limiting example of a fourth ethylene polymer consistent with the present invention can have (or can be characterized by) a high load melt index (HLMI) in a range from 4 to 15 g/10 min, a density in a range from 0.94 to 0.96 g/cm³, and a tan δ at 0.1 sec⁻¹ in a range from 1 to 1.5 degrees.

An illustrative and non-limiting example of a fifth ethylene polymer consistent with the present invention can have (or can be characterized by) a high load melt index (HLMI) in a range from 4 to 15 g/10 min, a density in a range from 0.94 to 0.96 g/cm³, and from 3 to 10 long chain branches (LCBs) per 1,000,000 total carbon atoms.

These illustrative and non-limiting examples of the first ethylene polymer, the second ethylene polymer, the third ethylene polymer, the fourth ethylene polymer, and the fifth ethylene polymer consistent with the present invention also can have any of the polymer properties listed below and in any combination, unless indicated otherwise.

The high load melt index (HLMI) of these ethylene polymers, in some aspects, can be in a range from 4 to 12 g/10 min, from 4 to 10 g/10 min, from 5 to 15 g/10 min, from 5 to 12 g/10 min, from 5 to 10 g/10 min, from 6 to 12 g/10 min, from 7 to 15 g/10 min, from 7 to 12 g/10 min, from 7 to 11 g/10 min, from 7 to 10 g/10 min, or from 8 to 10 g/10 min.

The densities of these ethylene-based polymers are greater than or equal to 0.94 g/cm³ and less than or equal to 0.96 g/cm³. Representative ranges for the density of these polymers can include from 0.942 to 0.96 g/cm³, from 0.945 to 0.96 g/cm³, from 0.945 to 0.956 g/cm³, from 0.945 to 0.952 g/cm³, from 0.948 to 0.96 g/cm³, from 0.948 to 0.958 g/cm³, from 0.948 to 0.954 g/cm³, or from 0.948 to 0.952 g/cm³.

In an aspect, these ethylene polymers can have a CY-a parameter in a range from 0.2 to 0.28. Other suitable ranges for the CY-a parameter include, but are not limited to, from 0.2 to 0.275, from 0.22 to 0.28, from 0.22 to 0.275, from 0.24 to 0.28, or from 0.24 to 0.275, and the like. Additionally or alternatively, these ethylene polymers can have a relaxation time (Tau(eta) or τ(η)) in a range from 4 to 20 sec. Other suitable ranges for the relaxation time include, but are not limited to, from 4 to 15 sec, from 4 to 12 sec, from 4 to 10 sec, from 4.25 to 20 sec, from 4.25 to 15 sec, from 4.25 to 12 sec, from 4.25 to 10 sec, from 4.5 to 20 sec, from 4.5 to 15 sec, from 4.5 to 12 sec, from 4.5 to 10 sec, or from 4.5 to 9 sec. A polymer relaxation time typically refers to the time it takes the polymer chains to return to equilibrium after being disturbed. Non-Newtonian fluids have a characteristic memory time scale which is referred to as the relaxation time. When the applied rate of deformation is reduced to zero, these materials relax over their characteristic relaxation time. Generally, Tau(eta) increases with molecular weight, however, the entanglements of the polymer, the long chain branching, the molecular weight, and the molecular weight distribution all influence the relaxation behavior. The CY-a and relaxation time parameters are determined from viscosity data measured at 190° C. and using the Carreau-Yasuda (CY) empirical model described herein.

While not limited thereto, the first ethylene polymer, the second ethylene polymer, the third ethylene polymer, the fourth ethylene polymer, and the fifth ethylene polymer can have a zero-shear viscosity (η0) in a range from 475 to 2000 kPa-s, such as from 475 to 1200 kPa-s in one aspect, from 475 to 1000 kPa-s in another aspect, from 500 to 2000 kPa-s in another aspect, from 500 to 1200 kPa-s in another aspect, from 500 to 1100 kPa-s in another aspect, from 500 to 1000 kPa-s in another aspect, from 550 to 2000 kPa-s in another aspect, from 550 to 1200 kPa-s in yet another aspect, and from 550 to 1100 kPa-s in still another aspect. Additionally or alternatively, these ethylene polymers can have a tan δ (tan d or tangent delta) at 0.1 sec⁻¹ in a range from 1 to 1.5 degrees or from 1 to 1.45 degrees. Other suitable ranges for the tan δ at 0.1 sec⁻¹ include, but are not limited to, from 1.05 to 1.5 degrees, from 1.05 to 1.45 degrees, from 1.1 to 1.5 degrees, from 1.1 to 1.45 degrees, from 1.2 to 1.5 degrees, or from 1.2 to 1.45 degrees, and the like. The (low frequency) tan δ at 0.1 sec⁻¹ of greater than 1, as opposed to less than 1, is indicative of a polymer with relatively low elasticity at low shear, which can be beneficial for certain film applications, particularly for higher molecular weight polymers. The zero-shear and tan δ rheological parameters are determined from viscosity data measured at 190° C. and using the Carreau-Yasuda (CY) empirical model described herein.

Generally, ethylene polymers in aspects of the present invention deviate from linear polymers due to the presence of relatively small amounts of long chain branching, with typically less than or equal to 10 long chain branches (LCBs) per 1,000,000 total carbon atoms—using the Janzen-Colby model described herein. In some aspects, these ethylene polymers can contain from 3 to 10 LCBs, from 3 to 9 LCBs, from 3 to 8 LCBs, from 3 to 7 LCBs, or from 3 to 6 LCBs, per 1,000,000 total carbon atoms.

In an aspect, the first ethylene polymer, the second ethylene polymer, the third ethylene polymer, the fourth ethylene polymer, and the fifth ethylene polymer can have a weight-average molecular weight (Mw) in a range from 200,000 to 325,000 g/mol, from 200,000 to 300,000 g/mol, from 200,000 to 275,000 g/mol, from 225,000 to 325,000 g/mol, from 225,000 to 300,000 g/mol, or from 225,000 to 275,000 g/mol, and the like. Additionally or alternatively, these ethylene polymers can have a peak molecular weight (Mp) in a range from 90,000 to 200,000 g/mol, from 100,000 to 190,000 g/mol, from 100,000 to 170,000 g/mol, from 100,000 to 150,000 g/mol, from 110,000 to 190,000 g/mol, from 110,000 to 170,000 g/mol, or from 110,000 to 150,000 g/mol, and the like.

In an aspect, the ethylene polymers can have a ratio of Mw/Mn, or the polydispersity index, in a range from 20 to 40, such as from 20 to 38, from 20 to 35, from 20 to 32, from 22 to 40, from 22 to 36, from 22 to 32, from 24 to 40, from 24 to 38, from 24 to 34, from 26 to 38, from 26 to 36, or from 26 to 34, and the like.

Ethylene polymers consistent with certain aspects of the invention can have a bimodal molecular weight distribution (as determined using gel permeation chromatography (GPC) or other related analytical technique). Often, in a bimodal molecular weight distribution, there is a valley between the peaks, and the peaks can be separated or deconvoluted. Typically, a bimodal molecular weight distribution can be characterized as having an identifiable high molecular weight component (or distribution) and an identifiable low molecular weight component (or distribution).

Advantageously, and unexpectedly given the addition of peroxide, the first ethylene polymer, the second ethylene polymer, the third ethylene polymer, the fourth ethylene polymer, and the fifth ethylene polymer have exceptionally low gel counts. This is quantified by laser gel counting of 50 micron film produced from the respective ethylene polymer and counting the number of gels with a size in diameter of 200-800 microns, as further discussed in the example section that follows. The ethylene polymers disclosed herein can have a film gel count of less than or equal to 20 gels per ft², and in some aspects, less than or equal to 15, or less than or equal to 12, or less than or equal to 10, or less than or equal to 8, gels per ft².

Moreover, these ethylene polymers can be produced with Ziegler-Natta catalyst systems containing titanium (and magnesium). In some aspects, the first ethylene polymer, the second ethylene polymer, the third ethylene polymer, the fourth ethylene polymer, and the fifth ethylene polymer can contain an amount (in ppm by weight) of titanium in a range from 0.5 ppm to 15 ppm, although not limited thereto. More often, these ethylene polymers contain from 0.5 ppm to 10 ppm of titanium, from 1 ppm to 15 ppm of titanium, or from 1 ppm to 10 ppm of titanium.

Metallocene and chromium based catalysts systems are not required. Therefore, the ethylene polymer can contain no measurable amount of zirconium and/or hafnium and/or chromium (catalyst residue), i.e., less than 0.1 ppm by weight. In some aspects, the first ethylene polymer, the second ethylene polymer, the third ethylene polymer, the fourth ethylene polymer, and the fifth ethylene polymer can contain, independently, less than 0.08 ppm, less than 0.05 ppm, or less than 0.03 ppm, of zirconium or hafnium or chromium.

Additionally or alternatively, these ethylene polymers can contain less than or equal to 50 ppm (by weight) of calcium, and more often, the ethylene polymers contain less than or equal to 45 ppm, less than or equal to 40 ppm, less than or equal to 25 ppm, or less than or equal to 10 ppm of calcium. Although there are other sources of calcium, comparative polymers often use calcium stearate as an acid scavenger, resulting in calcium levels that are over 50 ppm and often range up to 150 ppm in the polymer.

### Articles and Film Products

Articles of manufacture can be formed from, and/or can comprise, the ethylene polymers of this invention and, accordingly, are encompassed herein. For example, articles which can comprise the polymers of this invention can include, but are not limited to, an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier, and the like. Various processes can be employed to form these articles. Non-limiting examples of these processes include injection molding, blow molding, rotational molding, film extrusion (blown film extrusion, cast film extrusion), sheet extrusion, profile extrusion, thermoforming, and the like.

Additionally, additives and modifiers often are added to these polymers in order to provide beneficial polymer processing or end-use product attributes. Such processes and materials are described in Modern Plastics Encyclopedia, Mid-November 1995 Issue, Vol. 72, No. 12; and Film Extrusion Manual—Process, Materials, Properties, TAPPI Press, 1992. For instance, the ethylene polymer (and therefore, the resultant article comprising the ethylene polymer, such as a blown film) can further comprise an additive comprising an antiblock additive, a slip additive, a phenolic antioxidant, a phosphite antioxidant, a colorant, a filler, a UV additive, an anti-stat additive, a processing aid, or an acid scavenger, and the like. Combinations of two or more additives can be utilized in any combination and in any suitable amount in the ethylene polymer and the resultant article comprising the ethylene polymer. For instance, the ethylene polymer can contain an acid scavenger, and the acid scavenger can comprise zinc oxide, zinc stearate, calcium stearate, or a combination thereof; alternatively, zinc oxide and calcium stearate; alternatively, zinc stearate and calcium stearate; alternatively, zinc oxide; alternatively, zinc stearate; or alternatively, calcium stearate.

In some aspects of this invention, an article of manufacture can comprise any of the ethylene polymers described herein, and the article of manufacture can be or can comprise a film, i.e., the article can be or can comprise a (monolayer or multilayer) blown film or cast film. Films disclosed herein, whether cast or blown and whether monolayer or multilayer, can be any thickness that is suitable for the particular end-use application, and often, the average film thickness can be in a range from 0.3 to 20 mils or from 0.3 to 5 mils. For certain film applications, such as blown film applications, typical average film thicknesses can be in a range from 0.3 to 0.8 mils, from 0.4 to 2 mils, from 0.4 to 0.8 mils, from 0.5 to 2 mils, from 0.5 to 1.5 mils, or from 0.5 to 0.8 mils, and the like.

Notwithstanding the high density and high molecular weight of the ethylene polymers disclosed herein, the films have relatively good impact resistance. For instance, a blown film consistent with aspects of this invention can have a dart impact strength in a range from 50 to 500 g/mil, such as from 100 to 500 g/mil, from 100 to 400 g/mil, from 100 to 300 g/mil, from 150 to 400 g/mil, from 150 to 300 g/mil, or from 200 to 300 g/mil, while not limited thereto.

Likewise, given the high density and high molecular weight of the ethylene polymers disclosed herein, the films have relatively good tear resistance. The tear resistance of the films described herein can be characterized by the MD (or TD) Elmendorf tear strength. Suitable ranges for the MD tear strength can include, but are not limited to, from 5 to 100 g/mil, from 5 to 70 g/mil, from 5 to 60 g/mil, from 5 to 40 g/mil, from 10 to 100 g/mil, from 10 to 70 g/mil, or from 10 to 40 g/mil, and the like. Typical ranges for the TD tear strength can include, but are not limited to, from 150 to 1000 g/mil, from 150 to 800 g/mil, from 150 to 500 g/mil, from 200 to 1000 g/mil, from 200 to 800 g/mil, or from 200 to 500 g/mil, and the like.

Beneficially, the film products encompassed herein also can be characterized by surprisingly low thickness variation. In one aspect, the film thickness variation (2 sigma coefficient of variation) of a blown film can fall within a range from 5% to 35%, while in another aspect, the film thickness variation can range from 10% to 35%, from 5% to 25% in another aspect, from 10% to 25% in another aspect, from 10% to 22% in another aspect, from 5% to 20% in another aspect, from 10% to 18% in another aspect, from 5% to 15% in yet another aspect, and from 5% to 12% in still another aspect.

### Methods for Reducing Film Thickness Variation

In accordance with aspects of this invention, methods for reducing film thickness variation are provided herein. In one aspect, a first method for making an ethylene polymer with reduced film thickness variation is provided, and in this aspect, the first method can comprise melt processing a mixture (or alternatively referred to herein as a blend) of a base polymer (or alternatively referred to herein as a base resin) and a peroxide compound through a die to produce the ethylene polymer. The amount of the peroxide compound is from 1 to 10 ppm by weight of peroxide groups based on the weight of the base polymer (or based on the weight of the resultant ethylene polymer). The film thickness variation of a blown film produced from the ethylene polymer is less than that of the base polymer. As discussed further in the example section that follows, for this first method, film thicknesses are determined in accordance with D8136, and the film thickness variation of blown film at either 0.5 mils or 1 mil is determined using a LabTech blown film extrusion system equipped with a 30 L/D, 40 mm diameter single-screw extruder with a Maddock mixing section and a Pineapple mixing section at the end of the screw, and a 2-inch diameter spiral die with a 1 mm (40 mil) die gap and a single-lip air ring. Blown films are produced using a standard high stalk blown film process for HDPE, which includes a neck height (stalk height) of 14 inch, a frost line height (FLH) of 18 inch, and a blow-up ratio (BUR) of 4:1. Extruder output rate is 35 lb/hr, and the extruder barrel and die temperatures are set at 380° F. (193° C.).

In another aspect, a second method for reducing film thickness variation of a film is provided, and in this aspect, the second method can comprise (i) melt processing a mixture (or alternatively referred to herein as a blend) of a base polymer (or alternatively referred to herein as a base resin) and a peroxide compound through a die to produce an ethylene polymer, and (ii) melt processing the ethylene polymer through a film die to produce the film. The amount of the peroxide compound is from 1 to 10 ppm by weight of peroxide groups based on the weight of the base polymer (or based on the weight of the resultant ethylene polymer. The film thickness variation of the film produced from the ethylene polymer is less than that of the base polymer, under the same film processing conditions.

In these methods, the ethylene polymer can be in any suitable form, such as pellets or beads and the like. Similarly, the base polymer or base resin can be in any suitable form, such as fluff or powder and the like. Generally, the amount (ppm by weight) of the peroxide compound used in the first and second methods is of lesser interest, because the amount of peroxide groups is more important, and the molecular weight and the number of peroxide groups per peroxide compound are not consistent amongst all suitable peroxide compounds. Generally, the amount of peroxide groups, based on the weight of the base resin (or based on the weight of the ethylene polymer), can be in a range from 1 to 10 ppm, and more often, the amount of the peroxide compound is from 1 to 8 ppm, from 1 to 7 ppm, from 2 to 8, from 2 to 7 ppm, or from 2 to 6 ppm of the peroxide groups based on the weight of the base polymer (or based on the weight of the ethylene polymer).

The present invention is not limited to any particular method of contacting and melt processing the mixture of the base resin and the peroxide compound. Various methods of mixing and/or compounding can be employed, as would be recognized by those of skill in the art. Ordinarily, however, the melt processing of the mixture of the base polymer and the peroxide compound to form the ethylene polymer utilizes extrusion. For example, the melt processing of the mixture of the base polymer and the peroxide compound to form the ethylene polymer can be performed in a twin screw extrusion system (e.g., a counter-rotating mixer or a co-rotating twin screw extrusion system). The twin screw extrusion system can include any combination of feeding, melting, mixing, and conveying elements. For instance, the twin screw extrusion system can contain all or a majority of mixing elements. While not limited thereto, melt processing of the mixture of the base polymer and the peroxide compound is through a pelletizing die or a strand die to form the ethylene polymer (e.g., in pellets).

In these methods, the mixture or blend of the base polymer and the peroxide compound can be melt processed at any suitable melt processing temperature, such as, for example, a temperature in a range from 130 to 400° C., a temperature in a range from 150 to 300° C., a temperature in a range from 175 to 275° C., and so forth. The appropriate temperature may depend upon the composition of the peroxide compound and the temperature at which it liberates peroxide groups, but generally is a temperature sufficient to generate peroxide groups at from 1 to 10 ppm, from 1 to 8 ppm, from 1 to 7 ppm, from 2 to 8, from 2 to 7 ppm, or from 2 to 6 ppm of peroxide groups based on the weight of the base polymer (or the ethylene polymer).

The peroxide compound can be any compound containing one or more peroxide (O—O) groups, suitable examples of which can include, but are not limited to, 2,5-dimethyl-2,5-di(t-butylperoxy) hexane, dicumyl peroxide, t-butyl cumyl peroxide, n-butyl-4,4′-di(t-butylperoxy) valerate, 2,5-dimethyl-2,5-di(tert-butylperoxy) hexyne-3, and the like. Combinations of two or more of the peroxide compounds can be utilized, if desired. An example of a compound with three peroxide groups is 2,5-dimethyl-2,5-di(tert-butylperoxy) hexyne-3.

The peroxide compound can be, for instance, added as a solid prill, dissolved in a mineral oil, or in a liquid form. In one aspect, the peroxide compound can be present in a polymer masterbatch at any suitable loading, with representative loadings in a range from 0.5 to 40 wt. %, from 10 to 75 wt. %, from 10 to 60 wt. %, from 10 to 50 wt. %, or from 15 to 40 wt. %, based on a total weight of the polymer masterbatch. In another aspect, the peroxide compound can be present in a (non-polymer) masterbatch at any suitable loading, with representative loadings in a range from 0.5 to 50 wt. %, from 10 to 75 wt. %, from 25 to 60 wt. %, from 30 to 55 wt. %, or from 35 to 50 wt. %, based on a total weight of the masterbatch. In this aspect, the masterbatch ordinarily contains less than 8 wt. % of a polyolefin, and more often, contains less than 5 wt. %, or less than 2 wt. % of a polyolefin. Although not limited thereto, a typical technique uses a masterbatch of the peroxide compound, and contacts the base resin (in fluff form) during melt processing.

One or more additives also can be added during the conversion of the base polymer (and peroxide compound) into the ethylene polymer. Non-limiting examples of suitable additives that can be present in the base polymer and/or the ethylene polymer include an antiblock additive, a slip additive, a phenolic antioxidant, a phosphite antioxidant, a colorant, a filler, a UV additive, an anti-stat additive, a processing aid, or an acid scavenger, and the like. Combinations of two or more additives can be utilized in any combination and in any suitable amount in the base resin and/or the ethylene polymer. For instance, the base resin and/or the ethylene polymer can contain an acid scavenger, and the acid scavenger can comprise zinc oxide, zinc stearate, calcium stearate, or a combination thereof; alternatively, zinc oxide and calcium stearate; alternatively, zinc stearate and calcium stearate; alternatively, zinc oxide; alternatively, zinc stearate; or alternatively, calcium stearate.

Referring now to the second method, the ethylene polymer is melt processed in step (ii) through a film die to produce the film. While not limited thereto, the melt processing of the ethylene polymer through the film die to produce the film ordinarily utilizes extrusion. For example, the melt processing of the ethylene polymer to form the film can be performed in a single screw extrusion system. In one aspect of the second method, the film die is a blown film die and the film is a blown film, while in another aspect, the film die is a cast film die and the film is a cast film.

In the second method, the ethylene polymer can be melt processed at any suitable melt processing temperature, such as, for example, a temperature in a range from 150 to 400° C., a temperature in a range from 150 to 300° C., a temperature in a range from 175 to 250° C., and so forth. The appropriate temperature may depend upon the type of film die utilized and the type of film produced (e.g., blown versus cast), as well as the end-use application for the blown film or cast film, amongst other variables.

Referring now to both the first method and the second method, the film (or the blown film) can be any suitable thickness, and often, the average film thickness can be in a range from 0.3 to 20 mils or from 0.3 to 5 mils. For certain film applications, such as blown film applications, typical average film thicknesses can be in a range from 0.3 to 0.8 mils, from 0.4 to 2 mils, from 0.4 to 0.8 mils, from 0.5 to 2 mils, from 0.5 to 1.5 mils, or from 0.5 to 0.8 mils, and the like.

Advantageously, the film (or the blown film) produced from the ethylene polymer in the first and second methods has an improved (reduced) film thickness variation, unexpectedly, due to the addition of the low loading of the peroxide compound. In one aspect, for instance, the film (or the blown film) has a film thickness variation (using a 2 sigma coefficient of variation) in a range from 5% to 35%, while in another aspect, the film thickness variation is from 10% to 35%, from 5% to 25% in another aspect, from 10% to 25% in another aspect, from 10% to 22% in another aspect, from 5% to 20% in another aspect, from 10% to 18% in another aspect, from 5% to 15% in yet another aspect, and from 5% to 12% in still another aspect.

Also advantageously, the film (or the blown film) produced from the ethylene polymer in the first and second methods has a reduced film thickness variation, unexpectedly, of at least 5% less due to the addition of the low loading of the peroxide compound. In one aspect, for instance, the film (or the blown film) has a film thickness variation that is at least 5% less than that of the base polymer (or base resin), while in another aspect, the film thickness variation is at least 10% less than that of the base polymer, and in another aspect, the film thickness variation is at least 20% less than that of the base polymer, and in yet another aspect, the film thickness variation is at least 25% less than that of the base polymer, and in still another aspect, the film thickness variation is at least 50% less than that of the base polymer. As a representative example, if the film thickness variation (using a 2 sigma coefficient of variation) of the film (or the blown film) produced from the base resin is 15% and the analogous film thickness variation produced from the ethylene polymer is 12% (or in another example, 10%), this represents a reduction in film thickness variation of 20% (or in another example, 33%).

The base polymer (or base resin) that is used to produce the ethylene polymer in the first method and the second method can be any homopolymer of ethylene or copolymer, terpolymer, etc., of ethylene and at least one olefin comonomer. Thus, the base polymer (and the ethylene polymer) can comprise an ethylene/α-olefin copolymer, while in another aspect, the base polymer (and the ethylene polymer) can comprise an ethylene homopolymer, and in yet another aspect, the base polymer (and the ethylene polymer) can comprise an ethylene/α-olefin copolymer and an ethylene homopolymer. Accordingly, the base polymer (and the ethylene polymer) can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer. Typically, for example, if the base polymer (or the base resin) is an ethylene/1-hexene copolymer, then the ethylene polymer produced from the base resin also is an ethylene/1-hexene copolymer, although mixtures and combinations of various types of homopolymers and copolymers can be used.

In order to produce an ethylene polymer having the properties and benefits disclosed herein, a suitable base polymer (or base resin) is used. An illustrative and non-limiting example of a base polymer of the present invention can have a high load melt index (HLMI) in a range from 4 to 15 g/10 min and a density in a range from 0.94 to 0.96 g/cm³, and one or more of the following properties: a zero-shear viscosity (η₀) in a range from 300 to less than 450 kPa-s, a relaxation time (Tau(eta) or τ(η)) in a range from 2 to less than 4 sec, a CY-a parameter in a range from greater than 0.28 to 0.33, a tan δ at 0.1 sec⁻¹ in a range from greater than 1.5 to 1.75 degrees, and/or from 1.5 to less than 3 long chain branches (LCBs) per 1,000,000 total carbon atoms. The base polymer can be further characterized by a ratio of Mw/Mn of from 20 to 40, and/or a Mw of from 200,000 to 325,000 g/mol, and/or a Mp from 90,000 to 200,000 g/mol, and in some aspects, the base polymer can a ratio of Mw/Mn of from 20 to 40, and a Mw of from 200,000 to 325,000 g/mol, and a Mp from 90,000 to 200,000 g/mol. Additionally, the base polymer can have a bimodal molecular weight distribution.

Generally, the base polymers can be produced with Ziegler-Natta catalyst systems containing titanium (and magnesium). Representative Ziegler-Natta catalyst systems, reactor types, and polymerization reaction conditions that can be used to produce the base polymer resin are disclosed in U.S. Pat. Nos. 3,248,179, 4,501,885, 5,565,175, 5,575,979, 6,239,235, 6,262,191, 6,833,415, 7,226,886, 8,822,608, 9,963,523, 10,799,847, 10,844,147, 11,186,707, 11,453,733, 11,767,378, and 11,845,815, and EP 4019583.

In some aspects, the base polymer (and the ethylene polymer) can contain an amount (in ppm by weight) of titanium in a range from 0.5 ppm to 15 ppm, although not limited thereto. More often, these polymers contain from 0.5 ppm to 10 ppm of titanium, from 1 ppm to 15 ppm of titanium, or from 1 ppm to 10 ppm of titanium.

Metallocene and chromium based catalysts systems are not required. Therefore, the base polymer (and the ethylene polymer) can contain no measurable amount of zirconium and/or hafnium and/or chromium (catalyst residue), i.e., less than 0.1 ppm by weight. In some aspects, the base polymer (and the ethylene polymer) can contain, independently, less than 0.08 ppm, less than 0.05 ppm, or less than 0.03 ppm, of zirconium or hafnium or chromium.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Melt index (MI, g/10 min) can be determined in accordance with ASTM D1238 at 190° C. with a 2.16 kg weight (condition F). High load melt index (HLMI, g/10 min) was determined in accordance with ASTM D1238 at 190° C. with a 21.6 kg weight (condition E). Density was determined in grams per cubic centimeter (g/cm³) on a compression molded sample, cooled at 15° C. per minute, and conditioned for 40 hours at room temperature in accordance with ASTM D1505 and ASTM D4703.

Molecular weights and molecular weight distributions were obtained using a PL-220 GPC (Polymer Labs, an Agilent Company) system equipped with a IR4 detector (Polymer Char, Spain) and three Styragel HMW-6E GPC columns (Waters, 12-20 μm pore size, 7.8 mm×300 mm) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were approximately 1 mg/mL, depending on the molecular weight. Sample preparation was conducted at 150° C. for nominally 4 hr with occasional and gentle agitation, before the solutions were transferred to sample vials for injection. An injection volume of about 400 μL was used. The integral calibration method was used to deduce molecular weights and molecular weight distributions using a Chevron Phillips Chemical Company's HDPE polyethylene resin, MARLEX® BHB5003, as the standard. An integral table of the broad standard was pre-determined in a separate experiment with SEC-MALS. Mn is the number-average molecular weight, Mw is the weight-average molecular weight, Mz is the z-average molecular weight, Mv is the viscosity-average molecular weight, and Mp is the peak molecular weight (location, in molecular weight, of the highest point of the molecular weight distribution curve).

Melt rheological characterizations were performed as follows. Small-strain (less than 10%) oscillatory shear measurements were performed on an Anton Paar MCR-302 rheometer using parallel-plate geometry. All rheological tests were performed at 190° C. The complex viscosity |η*| versus frequency (ω) data were then curve fitted using the modified three parameter Carreau-Yasuda (CY) empirical model to obtain the zero shear viscosity-no, characteristic viscous relaxation time—τ_{η}, and the breadth parameter—a (CY-a parameter). The simplified Carreau-Yasuda (CY) empirical model is shown in Equation 3:

$$\vert η * ( ω ) \vert = \frac{{η}_{0}}{{[ 1 + {( {τ}_{η} ω )}^{a} ]}^{( 1 - n ) / a}} , \qquad Eq . 3$$

wherein:
   |η*(ω)|=magnitude of complex shear viscosity;
η₀=zero shear viscosity;
τ_{η}=viscous relaxation time (Tau(η));
a=“breadth” parameter (CY-a parameter);
n=fixes the final power law slope, fixed at 2/11; and
ω=angular frequency of oscillatory shearing deformation.

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong, and O. Hasseger, Dynamics of Polymeric Liquids, Volume 1, Fluid Mechanics, 2nd Edition, John Wiley & Sons (1987); each of which is incorporated herein by reference in its entirety.

For the dynamic frequency sweep measurements, the polymer samples were compression molded at 182° C. for a total of 3 min. The samples were allowed to melt at a relatively low pressure for 1 min and then subjected to a high molding pressure for an additional 2 min. The molded samples were then quenched in a room temperature press, and then 25 mm diameter disks were stamped out of the molded slabs for the measurement in the rotational rheometer. The measurements were performed in parallel plates of 25 mm diameter at 190° C. using a rotational rheometer (MCR-302, Anton Paar). The test chamber of the rheometer was purged with nitrogen to minimize oxidative degradation. After thermal equilibrium, the specimens were squeezed between the plates to a 1.6 mm thickness, and the excess was trimmed. For the dynamic frequency sweep measurement, small strain (1˜10%) oscillatory shear in the linear viscoelastic regime was applied at angular frequencies from 0.0316 to 316 sec⁻¹.

The long chain branches (LCBs) per 1,000,000 total carbon atoms of the overall polymer were calculated using the method of Janzen and Colby (J. Mol. Struct., 485/486, 569-584 (1999)), from values of zero shear viscosity, no (determined from the Carreau-Yasuda model, described hereinabove), and measured values of Mw obtained using GPC discussed above.

The RHEOTENS 71.97 measures the extensional properties of polymer melts by drawing a vertical melt strand at a constant pull-off speed or with a linear or exponentially accelerating velocity. The RHEOTENS 71.97 measures the force needed to elongate the strand, and calculates elongational stress, draw down ratios, rate of elongation and elongational viscosity. The RHEOTENS 71.97 was used in combination with a ¾-inch diameter single-screw extruder equipped with a melt pump using a 90° deflection head (or exit) die. The melt strand was taken-off only vertically. The melt strength was measured at a melt pump speed of 50 rpm.

For the blown film samples, film thickness and thickness variations were determined using a Model CX-1020 film thickness gauge in accordance with ASTM D8136.

Dart impact strength (g) was measured in accordance with ASTM D1709 (method A). Film machine direction (MD) and transverse direction (TD) Elmendorf tear strengths (g/mil) were measured on a Testing Machines tear tester (Model 83-11-00) in accordance with ASTM D1922. Tensile properties, such as yield strength, elongation at break, and 1% secant modulus were determined in accordance with ASTM D638.

Calcium and zinc content of the polymer were determined using XRF analysis. Metals content, such as the amount of catalyst residue in the polymer or article, can be determined by ICP analysis on a PerkinElmer Optima 8300 instrument. Polymer samples can be ashed in a Thermolyne furnace with sulfuric acid overnight, followed by acid digestion in a HotBlock with HCl and HNO₃ (3:1 v:v).

### Examples 2-12 and Comparative Examples C1 and CA-CE

The HDPE resin of Comparative Example C1 was a commercially-available ethylene/1-hexene copolymer (Chevron Phillips Chemical Company LP) produced using a Ziegler-Natta catalyst system. Comparative Example C1 contained 500 ppm primary antioxidant, 1000 ppm secondary antioxidant, and 500 ppm zinc stearate (ZnSt) acid scavenger additive. The HDPE polymers of Examples 2-9 were prepared by first dry blending the base polymer of Comparative Example C1 (no peroxide) with 10, 20, 30, 40, 50, 60, 80, and 100 ppm by weight (ppmw) of a peroxide compound using a masterbatch containing a polypropylene (PP) carrier resin and 20 wt. % of 2,5-dimethyl-2,5-di(t-butylperoxy) hexane. Based on the 22 wt. % of the two O—O groups in the peroxide compound, the 10 ppmw to 100 ppmw peroxide compound loadings for Examples 2-9 equates to about 2.2 ppmw to 22.2 ppmw peroxide groups, respectively, based on the weight of the base polymer.

The blends of the base polymer (Comparative Example C1) and peroxide masterbatch were melt processed using a twin screw extrusion system, and then pelletized to form the ethylene/1-hexene copolymers of Examples 2-9. Melt processing was performed on a laboratory ZSK-40 twin screw extruder equipped with a melt pump. The extruder was a super compounder with an OD/ID ratio of 1.55 and a 40 mm screw diameter and L/D ratio of 28.875. Nitrogen purge was used at the extruder feed port. The temperatures for the barrels, melt pump, and the die were set at 232° C. Conditions of extrusion rate (48.53 kg/hr), screw speed (265 rpm), and 20 mesh filter screen were used, and resulted in a melt temperature of 257° C. and specific energy of 0.161 kW-hr/kg. A 10-hole strand die plate, a waterbath, and a strand pelletizer were used to produce pellet samples. The pellet count was adjusted to 37 per gram.

The HDPE resins of Examples 10-12 were prepared as described for Examples 2-9, except that 20, 60, and 100 ppm by weight (ppmw) of the peroxide compound were added using a masterbatch containing a calcium carbonate (CaCO₃) carrier and 45 wt. % of 2,5-dimethyl-2,5-di(t-butylperoxy) hexane.

Table I summarizes certain properties of the base polymer of Comparative Example C1 and the peroxide-treated ethylene polymers of Examples 2-12. Also included in Table I are Comparative Examples CA-CE. Comparative Examples CA-CC were commercially-available Ziegler-Natta-catalyzed high density ethylene copolymer resins from Chevron-Philips Chemical Company LP similar in melt flow and density to C1, and Comparative Examples CD-CE were commercially-available HDPE resins.

As shown in Table I, the peroxide-treated ethylene polymers of Examples 2-12 exhibited a decrease in high load melt index (HLMI), as compared to the base polymer of Comparative Example C1. Generally, the polymers of Examples 2-12 had HLMI values in the 4 to 15 g/10 min range and densities in the 0.94 to 0.96 g/cm³ range. Table I also demonstrates that the peroxide-treated polymers of Examples 10-12, as compared to Comparative Examples CD-CE, contained significantly lower amounts of calcium; the peroxide-treated polymers of Examples 10-12 contained from 6.6 ppm to 30.2 ppm calcium, respectively.

For the base polymer of Comparative Example C1, the peroxide-treated polymers of Examples 2-12, and the polymers of Comparative Examples CA-CE, Table II summarizes molecular weight characteristics, while Table III summarizes certain rheological properties at 190° C. Generally, the peroxide-treated polymers of Examples 2-12 had ratios of Mw/Mn in the 20 to 40 range, Mw values in the 200,000 to 325,000 range, Mp values in the 90,000 to 200,000 range, and tan δ at 0.1 sec⁻¹ values in the 1 to 1.5 degrees range.

Table IV summarizes certain rheological properties at 190° C. using the Carreau-Yasuda (CY) empirical model and the number of long-chain branches (LCBs) per 1,000,000 total carbon atoms using the Janzen-Colby model for the base polymer of Comparative Example C1, the peroxide-treated polymers of Examples 2-12, and the polymers of Comparative Examples CA-CE. Generally, the peroxide-treated polymers of Examples 2-12 had zero-shear viscosity (η₀) values from 475 to 1200 kPa-sec, relaxation time (Tau(eta) or τ(η)) values from 4 to 15 sec, CY-a parameters in the 0.2 to 0.28 range, and from 3 to 10 long chain branches (LCBs) per 1,000,000 total carbon atoms. As shown in Table IV, as the peroxide amount was increased, the zero-shear viscosity, the relaxation time, and the number of long chain branches increased, while the CY-a parameter decreased.

Table V summarizes the melt strength at a draw down ratio of 2.6 (N) for the base polymer of Comparative Example C1, the peroxide-treated polymers of Examples 2-12, and the polymers of Comparative Examples CA-CE. Generally, as the peroxide amount was increased, the melt strength increased.

Blown film samples at a 1-mil thickness (25 microns) and 0.5-mil thickness (13 microns) were produced from the base polymer of Comparative Example C1, the peroxide-treated ethylene polymers of Examples 2-12, and the polymers of Comparative Examples CA-CE. The blown film samples were produced on a LabTech laboratory-scale blown film line using high stalk high density polyethylene conditions (HDPE) as follows: 2-inch diameter spiral die, 1 mm die gap, single lip air ring, 40 mm diameter single-screw extruder with a Maddock mixing section and a Pineapple mixing section at the end of the screw (L/D=30), neck height (stalk height) was 14-inch, frost line height (FLH) was 18-inch, blow-up ratio (BUR) was 4:1, and 35 lb/hr output rate. The extruder barrel and the die temperatures were set at 193° C. flat. These particular processing conditions were chosen because the blown film properties so obtained are typically representative of those obtained from larger, commercial scale film blowing conditions.

Table VI summarizes the thickness variations and Table VII summarizes the MD and TD Elmendorf tear strengths and dart drop impact strengths for the 1.0 mil and 0.5 mil thick blown film samples. Generally, the blown films produced from the peroxide-treated ethylene polymers of Examples 2-4 had a film thickness variation (2 sigma coefficient of variation (CoV) equals (Standard Deviation/Average Thickness)*2*100%)) in the 5% to 15% range, a dart impact strength in the 100 to 500 g/mil range, a MD Elmendorf tear strength in the 5 to 60 g/mil range, and a TD Elmendorf tear strength in the 150 to 1000 g/mil range. Significantly, the film thickness variation of the blown film produced from the peroxide-treated ethylene polymers of Examples 2-4 was unexpectedly less than the film thickness variation of the base polymer of Comparative Example C1 and that of Comparative Examples CB and CD-CE. Table VIII summarizes the tensile properties for 1-mil blown film samples and Table IX summarizes the tensile properties for 0.5-mil blown film samples.

Table X provides a comparison of the amount of gels in the film samples produced from base polymer of Comparative Example C1, the peroxide-treated polymers of Examples 2-12, and the polymers of Comparative Examples CA-CE. Gels were measured on 50 micron (2 mil) thick films using an automated camera-based gel counting machine made by Optical Control System (OCS), Model FSA-100. The system consisted of a light source and a detector. The film was passed through the system, between the light source and the detector. A total of 3 square meters of film area was inspected and the gels with sizes (diameters) in the 200-800 micron range were analyzed. The gel counts represent the total gels, irrespective of the source/cause of the gels, on a number of gels/square foot basis. Unexpectedly, the peroxide-treated ethylene polymers of Examples 2-10 had significantly less gels than that of the commercial ethylene polymers of Comparative Examples CD-CE. Further, despite the addition of the peroxide compound, the gel counts of most of the inventive examples were surprisingly less than 10 gels/ft².

### Inventive Examples 14-19 and 21-24, and C13, C20, and CD-CF

The HDPE resin of Comparative Example C13 was a commercially-available ethylene/1-hexene copolymer (Chevron Phillips Chemical Company LP) produced using a Ziegler-Natta catalyst system. Comparative Example C13 contained 500 ppm primary antioxidant, 1000 ppm secondary antioxidant, and 500 ppm zinc stearate (ZnSt) acid scavenger additive. The HDPE polymers of Examples 14-16 were prepared by first dry blending the base polymer of Comparative Example C13 (no peroxide) with 10, 20, and 30 ppm by weight (ppmw) of a peroxide compound using a masterbatch containing a polypropylene (PP) carrier resin and 7.5 wt. % of 2,5-dimethyl-2,5-di(t-butylperoxy) hexane. Based on the 22 wt. % of the two O—O groups in the peroxide compound, the 10 ppmw to 30 ppmw peroxide compound loadings for Examples 14-16 equates to about 2.2 ppmw to 6.6 ppmw peroxide groups, respectively, based on the weight of the base polymer. The blends of the base polymer (Comparative Example C13) and peroxide masterbatch were melt processed using a twin screw extrusion system, and then pelletized to form the ethylene/1-hexene copolymers of Examples 14-16 in the same manner as that described above for Examples 2-9.

The HDPE resins of Examples 17-19 were prepared as described for Examples 14-16, except that 10, 20, and 30 ppm by weight (ppmw) of the peroxide compound were added using a masterbatch containing a calcium carbonate (CaCO₃) carrier and 5 wt. % of 2,5-dimethyl-2,5-di(t-butylperoxy) hexane. Blown film samples at a 1-mil thickness (25 microns) and 0.5-mil thickness (13 microns) were produced from the base polymer of Comparative Example C13 and the peroxide-treated ethylene polymers of Examples 14-19 in the same manner as that described above for Examples 2-12.

The HDPE resin of Comparative Example C20 was a commercially-available ethylene/1-hexene copolymer (Chevron Phillips Chemical Company LP) produced using a Ziegler-Natta catalyst system, and with a slightly higher HLMI than C1 and C13. Comparative Example C20 contained 500 ppm primary antioxidant, 1000 ppm secondary antioxidant, and 500 ppm zinc stearate (ZnSt) acid scavenger additive. The HDPE polymers of Examples 21-24 were prepared by first dry blending the base polymer of Comparative Example C20 (no peroxide) with 10 and 20 ppm by weight (ppmw) of a peroxide compound using a masterbatch containing a polypropylene (PP) carrier resin and 5 wt. % of 2,5-dimethyl-2,5-di(t-butylperoxy) hexane. Examples 21-22 used a different masterbatch vendor from Examples 23-24, although the peroxide loading was the same. Based on the 22 wt. % of the two O—O groups in the peroxide compound, the 10 ppmw to 20 ppmw peroxide compound loadings for Examples 21-24 equates to about 2.2 ppmw to 4.4 ppmw peroxide groups, respectively, based on the weight of the base polymer. The blends of the base polymer (Comparative Example C20) and peroxide masterbatch were melt processed using a Kobelco Kobe LCM80 Continuous Mixer, which was 800 mm long (10:1 L/D) and had an 80 mm diameter. The Kobe LCM80 continuous mixer was equipped with a melt pump. Nitrogen purge was used at the continuous mixer feed port. An underwater pelletizer was used to produce pellet samples. The temperatures for the barrels, the melt pump, and the die were set at 232° C. The extrusion rate and the screw speed used were 220 kg/hr and 400 rpm, respectively.

Blown film samples at a 1-mil thickness (25 microns) and 0.5-mil thickness (13 microns) were produced from the base polymer of Comparative Example C20, the peroxide-treated ethylene polymers of Examples 21-24, and the polymer of Comparative Example CF. The blown film samples were produced on a BGE pilot-scale blown film line using a 6-inch diameter spiral die, a 1 mm die gap, a dual lip air ring, a 50 mm diameter single-screw extruder with a Maddock mixing section (L/D=30). The neck height (stalk height) was 42-inch, the frost line height (FLH) was 50-inch, the blow-up ratio (BUR) used was 4:1, and 225 lb/hr output rate. The extruder barrel and the die temperatures were set at 193° C. flat. These particular processing conditions were chosen because the blown film properties so obtained are typically representative of those obtained from larger, commercial scale film blowing conditions.

Table XI summarizes certain properties of the base polymers of Comparative Examples C13 and C20 and the peroxide-treated ethylene polymers of Examples 14-19 and 21-24. Also included in Table XI are Comparative Examples CD-CF. Comparative Examples CD-CE were the commercially-available HDPE resins shown in previous tables, and Comparative Example CF was a commercially-available Ziegler-Natta-catalyzed high density ethylene copolymer resin from Chevron-Philips Chemical Company LP similar in melt flow and density to C13.

As shown in Table XI, the peroxide-treated ethylene polymers of Examples 14-19 exhibited a decrease in high load melt index (HLMI), as compared to the base polymer of Comparative Example C13, and the peroxide-treated ethylene polymers of Examples 21-24 exhibited a decrease in high load melt index (HLMI), as compared to the base polymer of Comparative Example C20. Generally, the polymers of Examples 14-19 and 21-24 had HLMI values in the 4 to 15 g/10 min range and densities in the 0.94 to 0.96 g/cm³ range. Table XI also demonstrates that the peroxide-treated polymers of Examples 14-16 and 21-24 had no measurable amounts of calcium.

For the base polymers of Comparative Examples C13 and C20, the peroxide-treated polymers of Examples 14-19 and 21-24, and the polymers of Comparative Examples CD-CF, Table XII summarizes molecular weight characteristics, while Table XIII summarizes certain rheological properties at 190° C. Generally, the peroxide-treated polymers of Examples 14-19 and 21-24 had ratios of Mw/Mn in the 20 to 40 range, Mw values in the 200,000 to 325,000 range, Mp values in the 90,000 to 200,000 range, and tan δ at 0.1 sec⁻¹ values in the 1 to 1.5 degrees range.

Table XIV summarizes certain rheological properties at 190° C. using the Carreau-Yasuda (CY) empirical model and the number of long-chain branches (LCBs) per 1,000,000 total carbon atoms using the Janzen-Colby model for the base polymers of Comparative Examples C13 and C20, the peroxide-treated polymers of Examples 14-19 and 21-24, and the polymers of Comparative Examples CD-CF. Generally, the peroxide-treated polymers of Examples 14-19 and 21-24 had zero-shear viscosity (η₀) values from 475 to 2000 kPa-sec, relaxation time (Tau(eta) or τ(η)) values from 4 to 20 sec, CY-a parameters in the 0.2 to 0.28 range, and from 3 to 10 long chain branches (LCBs) per 1,000,000 total carbon atoms. As shown in Table XIV, as the peroxide amount was increased, the zero-shear viscosity, the relaxation time, and the number of long chain branches increased, while the CY-a parameter decreased.

Table XV summarizes the melt strength at a draw down ratio of 2.6 (N) for the base polymers of Comparative Examples C13 and C20, the peroxide-treated polymers of Examples 14-19 and 21-24, and the polymers of Comparative Examples CD-CF. Generally, as the peroxide amount was increased, the melt strength increased.

Table XVI summarizes the thickness variations and Table XVII summarizes the MD and TD Elmendorf tear strengths and dart drop impact strengths for the 1.0 mil and 0.5 mil thick blown film samples. Generally, the blown films produced from the peroxide-treated ethylene polymers of Examples 14-19 and 21-24 had a film thickness variation (2 sigma coefficient of variation (CoV) equals (Standard Deviation/Average Thickness)*2*100%)) in the 5% to 35% range, a dart impact strength in the 100 to 500 g/mil range, a MD Elmendorf tear strength in the 10 to 100 g/mil range, and a TD Elmendorf tear strength in the 150 to 1000 g/mil range. Significantly, the film thickness variations of the blown films produced from the peroxide-treated ethylene polymers of Examples 14-19 were unexpectedly less than the film thickness variation of the base polymer of Comparative Example C13, and the film thickness variations of the blown films produced from the peroxide-treated ethylene polymers of Examples 21-24 were unexpectedly less than the film thickness variation of the base polymer of Comparative Example C20 (even though the variation was much higher for C20 than for C13). Table XVIII summarizes the tensile properties for 1-mil blown film samples and Table XIX summarizes the tensile properties for 0.5-mil blown film samples.

Table XX provides a comparison of the amount of gels in the film samples produced from the base polymers of Comparative Examples C13 and C20, the peroxide-treated polymers of Examples 14-19 and 21-24, and the polymers of Comparative Examples CD-CF. Gels were measured on 50 micron (2 mil) thick films as described above in relating to Table X. Unexpectedly, the peroxide-treated ethylene polymers of Examples 14-19 and 21-24 had significantly less gels than that of the commercial ethylene polymers of Comparative Examples CD-CE. Further, despite the addition of the peroxide compound, the gel counts of most of the inventive examples were surprisingly less than 10 gels/ft² (or less than 5 gels/ft²).

TABLE I
Polymer Properties.

| | Peroxide | DHBP | Ca | Zn | HLMI | Density |
|---|---|---|---|---|---|---|
| Example | (ppm) | Carrier | (ppm) | (ppm) | (g/10 min) | (g/cc) |
| C1 | 0 | | — | 54.8 | 8.88 | 0.9499 |
| 2 | 10 | PP | — | 50.9 | 8.16 | 0.9499 |
| 3 | 20 | PP | — | 45.5 | 8.43 | 0.9498 |
| 4 | 30 | PP | — | 49.9 | 8.49 | 0.9497 |
| 5 | 40 | PP | — | 44.2 | 7.59 | 0.9493 |
| 6 | 50 | PP | — | 48.9 | 7.98 | 0.9494 |
| 7 | 60 | PF | — | 51.3 | 7.93 | 0.9495 |
| 8 | 80 | PP | — | 50.7 | 8.13 | 0.9489 |
| 9 | 100 | PF | — | 51.2 | 7.31 | 0.9494 |
| 10 | 20 | CaCO₃ | 6.6 | 54.0 | 8.07 | 0.9496 |
| 11 | 60 | CaCO₃ | 18.9 | 53.2 | 7.96 | 0.9496 |
| 12 | 100 | CaCO₃ | 30.2 | 43.3 | 6.92 | 0.9493 |
| CA | — | — | — | 42.7 | 9.28 | 0.9499 |
| CB | — | — | — | 46.2 | 9.17 | 0.9496 |
| CC | — | — | — | — | 9.03 | 0.9505 |
| CD | — | — | 103 | — | 7.64 | 0.9508 |
| CE | — | — | 60.4 | 76.7 | 9.12 | 0.9491 |

TABLE II
Molecular Weight Characterization (molecular weights in kg/mol).

| Example | Mn | Mw | Mz | Mv | Mp | Mw/Mn | Mz/Mw |
|---|---|---|---|---|---|---|---|
| C1 | 7.0 | 269 | 1563 | 1363 | 142 | 38.7 | 5.8 |
| 2 | 8.7 | 274 | 1860 | 1577 | 127 | 31.6 | 6.8 |
| 3 | 8.8 | 253 | 1514 | 1301 | 134 | 28.7 | 6.0 |
| 4 | 8.9 | 249 | 1443 | 1248 | 127 | 28.2 | 5.8 |
| 5 | 8.5 | 242 | 1321 | 1153 | 141 | 28.5 | 5.5 |
| 6 | 8.7 | 235 | 1265 | 1102 | 129 | 27.0 | 5.4 |
| 7 | 8.8 | 233 | 1229 | 1073 | 139 | 26.4 | 5.3 |
| 8 | 8.7 | 230 | 1161 | 1022 | 157 | 26.6 | 5.0 |
| 9 | 8.6 | 228 | 1186 | 1036 | 137 | 26.5 | 5.2 |
| 10 | 8.7 | 248 | 1371 | 1193 | 120 | 28.4 | 5.5 |
| 11 | 8.9 | 232 | 1191 | 1045 | 131 | 26.1 | 5.1 |
| 12 | 8.8 | 222 | 1117 | 977 | 132 | 25.2 | 5.0 |
| CA | 9.0 | 270 | 1457 | 1428 | 139 | 29.9 | 5.4 |
| CB | 8.8 | 271 | 1530 | 1422 | 139 | 30.9 | 5.6 |
| CC | — | — | — | — | — | — | — |
| CD | 8.4 | 294 | 1634 | 1428 | 378 | 34.9 | 5.6 |
| CE | 10.1 | 284 | 1632 | 1422 | 20 | 28.3 | 5.7 |

TABLE III
Rheological Properties at 190° C.

| | G′ at | G′ at | G″ at | G″ at | Tan δ at | Tan δ at | G* at | G* at | η* at | η* at |
|---|---|---|---|---|---|---|---|---|---|---|
| | 0.1 1/s | 100 1/s | 0.1 1/s | 100 1/s | 0.1 sec⁻¹ | 100 1/s | 0.1 1/s | 100 1/s | 0.1 1/s | 100 1/s |
| Example | (kPa) | (kPa) | (kPa) | (kPa) | (degrees) | (degrees) | (kPa) | (kPa) | (kPa-s) | (kPa-s) |
| C1 | 4.77 | 196 | 7.33 | 101 | 1.54 | 0.515 | 8.8 | 220 | 87.5 | 2.21 |
| 2 | 5.53 | 202 | 7.87 | 103 | 1.42 | 0.510 | 9.6 | 227 | 96.2 | 2.27 |
| 3 | 6.34 | 204 | 8.36 | 103 | 1.32 | 0.505 | 10.5 | 229 | 100.5 | 2.29 |
| 4 | 6.60 | 203 | 8.46 | 102 | 1.28 | 0.502 | 10.7 | 227 | 107.4 | 2.27 |
| 5 | — | — | — | — | — | — | — | — | — | — |
| 6 | — | — | — | — | — | — | — | — | — | — |
| 7 | — | — | — | — | — | — | — | — | — | — |
| 8 | — | — | — | — | — | — | — | — | — | — |
| 9 | — | — | — | — | — | — | — | — | — | — |
| 10 | — | — | — | — | — | — | — | — | — | — |
| 11 | — | — | — | — | — | — | — | — | — | — |
| 12 | — | — | — | — | — | — | — | — | — | — |
| CA | 4.62 | 215 | 7.73 | 110 | 1.67 | 0.512 | 9.0 | 242 | 90.1 | 2.42 |
| CB | 4.64 | 215 | 7.73 | 110 | 1.67 | 0.512 | 9.0 | 241 | 90.2 | 2.41 |
| CC | — | — | — | — | — | — | — | — | — | — |
| CD | 5.46 | 216 | 8.58 | 107 | 1.57 | 0.495 | 10.2 | 241 | 101.8 | 2.41 |
| CE | 5.87 | 217 | 9.07 | 103 | 1.55 | 0.475 | 10.8 | 240 | 108.2 | 2.40 |

TABLE IV
Rheological Properties at 190° C. (Carreau-
Yasuda Model) and Number of LCBs per 1,000,000
Total Carbon Atoms (Janzen and Colby Model).

| | η₀ | τ(η) | CY-a | LCB per Million |
|---|---|---|---|---|
| Example | (kPa-sec) | (sec) | parameter | Carbon Atoms |
| C1 | 431 | 3.5 | 0.285 | 2.8 |
| 2 | 578 | 4.7 | 0.272 | 3.1 |
| 3 | 807 | 6.8 | 0.259 | 4.6 |
| 4 | 912 | 7.9 | 0.255 | 5.1 |
| 5 | — | — | — | — |
| 6 | — | — | — | — |
| 7 | — | — | — | — |
| 8 | — | — | — | — |
| 9 | — | — | — | — |
| 10 | — | — | — | — |
| 11 | — | — | — | — |
| 12 | — | — | — | — |
| CA | 351 | 2.5 | 0.305 | 2.5 |
| CB | 354 | 2.6 | 0.305 | 2.4 |
| CC | — | — | — | — |
| CD | 443 | 3.5 | 0.306 | 2.1 |
| CE | 445 | 3.8 | 0.321 | 2.4 |

TABLE V
Melt Strength at Draw Down Ratio
of 2.6 using RHEOTENS 71.97.

| | Melt Strength - Draw |
|---|---|
| Example | Down Ratio of 2.6 (N) |
| C1 | 0.456 |
| 2 | 0.477 |
| 3 | 0.482 |
| 4 | 0.490 |
| 5 | — |
| 6 | — |
| 7 | — |
| 8 | — |
| 9 | — |
| 10 | — |
| 11 | — |
| 12 | — |
| CA | 0.457 |
| CB | 0.455 |
| CC | — |
| CD | 0.514 |
| CE | 0.443 |

TABLE VI
Thickness Variations for Blown Film Samples.

| | Gauge Variation | Gauge Variation | 2 Sigma | 2 Sigma |
|---|---|---|---|---|
| | by Range - | by Range - | CoV - 1.0 | CoV - 0.5 |
| Example | 1.0 mil (%) | 0.5 mil (%) | mil (%) | mil (%) |
| C1 | 40 | 34 | 18 | 12 |
| 2 | 28 | 22 | 12 | 8 |
| 3 | 30 | 27 | 11 | 10 |
| 4 | 25 | 24 | 10 | 9 |
| 5 | — | — | — | — |
| 6 | — | — | — | — |
| 7 | — | — | — | — |
| 8 | — | — | — | — |
| 9 | — | — | — | — |
| 10 | — | — | — | — |
| 11 | — | — | — | — |
| 12 | — | — | — | — |
| CA | — | — | — | — |
| CB | 47 | 26 | 23 | 9 |
| CC | — | — | — | — |
| CD | 26 | 43 | 9 | 13 |
| CE | 28 | 33 | 13 | 11 |

TABLE VII
MD and TD Tear Strengths and Dart Drop
Impact Strength for Blown Film Samples.

| | Average | Average | Average | Average | Dart Drop | Dart Drop |
|---|---|---|---|---|---|---|
| | MD - | MD - | TD - | TD - | Impact - | Impact - |
| | 1.0 mil | 0.5 mil | 1.0 mil | 0.5 mil | 1.0 mil | 0.5 mil |
| Example | (g/mil) | (g/mil) | (g/mil) | (g/mil) | (g) | (g) |
| C1 | 40.0 | 14.0 | 309 | 446 | 278 | 124 |
| 2 | 39.6 | 14.0 | 255 | 407 | 250 | 102 |
| 3 | 36.0 | 13.7 | 225 | 392 | 238 | 84 |
| 4 | 35.0 | 12.6 | 211 | 412 | 230 | 98 |
| 5 | — | — | — | — | — | — |
| 6 | — | — | — | — | — | — |
| 7 | — | — | — | — | — | — |
| 8 | — | — | — | — | — | — |
| 9 | — | — | — | — | — | — |
| 10 | — | — | — | — | — | — |
| 11 | — | — | — | — | — | — |
| 12 | — | — | — | — | — | — |
| CA | — | — | — | — | — | — |
| CB | 38.1 | 12.2 | 415 | 381 | 244 | 174 |
| CC | — | — | — | — | — | — |
| CD | 24.0 | 10.4 | 223 | 409 | 242 | 78 |
| CE | 24.9 | 11.1 | 206 | 316 | 240 | 112 |

TABLE VIII
Tensile Properties for 1-mil Thick Blown Film Samples.

| | | | | MD | | TD |
|---|---|---|---|---|---|---|
| | MD 1% | TD 1% | MD | Tensile | TD | Tensile |
| | Secant | Secant | Strain | Strength | Strain | Strength |
| | Modulus | Modulus | at Break | at Break | at Break | at Break |
| Example | (psi) | (psi) | (%) | (psi) | (%) | (psi) |
| C1 | 116,822 | 128,352 | 378 | 7,690 | 533 | 6,973 |
| 2 | 125,412 | 159,888 | 408 | 7,993 | 509 | 7,489 |
| 3 | 126,138 | 154,156 | 409 | 7,946 | 495 | 7,950 |
| 4 | 123,690 | 148,892 | 394 | 7,640 | 507 | 7,788 |
| 5 | — | — | — | — | — | — |
| 6 | — | — | — | — | — | — |
| 7 | — | — | — | — | — | — |
| 8 | — | — | — | — | — | — |
| 9 | — | — | — | — | — | — |
| 10 | — | — | — | — | — | — |
| 11 | — | — | — | — | — | — |
| 12 | — | — | — | — | — | — |
| CA | — | — | — | — | — | — |
| CB | 126,126 | 138,616 | 370 | 8,151 | 540 | 7,598 |
| CC | — | — | — | — | — | — |
| CD | 123,040 | 150,834 | 418 | 9,378 | 500 | 6,952 |
| CE | 135,202 | 161,406 | 395 | 8,616 | 518 | 8,526 |

TABLE IX
Tensile Properties for 0.5-mil Thick Blown Film Samples.

| | | | | MD | | TD |
|---|---|---|---|---|---|---|
| | MD 1% | TD 1% | MD | Tensile | TD | Tensile |
| | Secant | Secant | Strain | Strength | Strain | Strength |
| | Modulus | Modulus | at Break | at Break | at Break | at Break |
| Example | (psi) | (psi) | (%) | (psi) | (%) | (psi) |
| C1 | 156,384 | 198,474 | 241 | 10,218 | 510 | 6,436 |
| 2 | 173,766 | 175,006 | 258 | 11,101 | 514 | 6,717 |
| 3 | 146,416 | 175,434 | 264 | 9,842 | 485 | 6,131 |
| 4 | 148,424 | 160,926 | 231 | 9,134 | 525 | 7,311 |
| 5 | — | — | — | — | — | — |
| 6 | — | — | — | — | — | — |
| 7 | — | — | — | — | — | — |
| 8 | — | — | — | — | — | — |
| 9 | — | — | — | — | — | — |
| 10 | — | — | — | — | — | — |
| 11 | — | — | — | — | — | — |
| 12 | — | — | — | — | — | — |
| CA | — | — | — | — | — | — |
| CB | 148,356 | 173,484 | 247 | 9,866 | 460 | 6,136 |
| CC | — | — | — | — | — | — |
| CD | 149,458 | 191,796 | 211 | 9,568 | 493 | 6,003 |
| CE | 114,119 | 179,646 | 263 | 11,476 | 479 | 5,410 |

TABLE X
Gel Count Comparison for Comparative Examples C1,
Examples 2-12, and Comparative Examples CA-CE.

| | Number of gels 200 μm to |
|---|---|
| Example | 800 μm (number per ft²) |
| C1 | 3.2 |
| 2 | 4.2 |
| 3 | 4.0 |
| 4 | 5.4 |
| 5 | 5.3 |
| 6 | 6.1 |
| 7 | 8.0 |
| 8 | 14.2 |
| 9 | 14.9 |
| 10 | 5.5 |
| 11 | — |
| 12 | — |
| CA | 0.8 |
| CB | 0.8 |
| CC | — |
| CD | 63.5 |
| CE | 21.0 |

TABLE XI
Polymer Properties.

| | Peroxide | DHBP | Ca | HLMI | Density |
|---|---|---|---|---|---|
| Example | (ppm) | Carrier | (ppm) | (g/10 min) | (g/cc) |
| C13 | 0 | | — | 9.01 | 0.9490 |
| 14 | 10 | PP | — | 8.27 | 0.9487 |
| 15 | 20 | PP | — | 7.70 | 0.9490 |
| 16 | 30 | PP | — | 7.82 | 0.9491 |
| 17 | 10 | CaCO₃ | 33.5 | 8.22 | 0.9487 |
| 18 | 20 | CaCO₃ | 67.1 | 7.68 | 0.9489 |
| 19 | 30 | CaCO₃ | 103 | 7.41 | 0.9491 |
| C20 | 0 | | — | 9.59 | 0.9496 |
| 21 | 10 | PP | — | 9.55 | 0.9494 |
| 22 | 20 | PP | — | 9.36 | 0.9494 |
| 23 | 10 | PP | — | 9.22 | 0.9496 |
| 24 | 20 | PP | — | 9.30 | 0.9493 |
| CD | — | — | 103 | 7.64 | 0.9508 |
| CE | — | — | 60.4 | 9.12 | 0.9491 |
| CF | — | — | — | 8.54 | 0.9494 |

TABLE XII
Molecular Weight Characterization (molecular weights in kg/mol).

| Example | Mn | Mw | Mz | Mv | Mp | Mw/Mn | Mz/Mw |
|---|---|---|---|---|---|---|---|
| C13 | 9.2 | 280 | 1627 | 1416 | 128 | 30.4 | 5.8 |
| 14 | 9.0 | 273 | 1568 | 1366 | 115 | 30.5 | 5.7 |
| 15 | 9.1 | 276 | 1695 | 1455 | 132 | 30.5 | 6.1 |
| 16 | 9.3 | 257 | 1505 | 1299 | 141 | 27.6 | 5.9 |
| 17 | 9.4 | 277 | 1587 | 1382 | 131 | 29.4 | 5.7 |
| 18 | 9.1 | 266 | 1491 | 1298 | 136 | 29.1 | 5.6 |
| 19 | 9.3 | 269 | 1549 | 1343 | 154 | 29.0 | 5.8 |
| C20 | 9.4 | 268 | 1590 | 191 | 123 | 28.6 | 5.9 |
| 21 | 10.1 | 245 | 1305 | 178 | 130 | 24.4 | 5.3 |
| 22 | 9.7 | 232 | 1242 | 169 | 121 | 23.9 | 5.4 |
| 23 | 9.9 | 242 | 1296 | 175 | 145 | 24.4 | 5.4 |
| 24 | 9.4 | 236 | 1221 | 172 | 123 | 25.2 | 5.2 |
| CD | 8.4 | 294 | 1634 | 1428 | 378 | 34.9 | 5.6 |
| CE | 10.1 | 284 | 1632 | 1422 | 20 | 28.3 | 5.7 |
| CF | 9.3 | 283 | 1634 | 200 | 138 | 30.5 | 5.8 |

TABLE XIII
Rheological Properties at 190° C.

| | G′ at | G′ at | G″ at | G″ at | Tan δ at | Tan δ at | G* at | G* at | η* at | η* at |
|---|---|---|---|---|---|---|---|---|---|---|
| | 0.1 1/s | 100 1/s | 0.1 1/s | 100 1/s | 0.1 sec⁻¹ | 100 1/s | 0.1 1/s | 100 1/s | 0.1 1/s | 100 1/s |
| Example | (kPa) | (kPa) | (kPa) | (kPa) | (degrees) | (degrees) | (kPa) | (kPa) | (kPa-s) | (kPa-s) |
| C13 | 4.64 | 205 | 7.54 | 105 | 1.63 | 0.514 | 8.86 | 231 | 88.6 | 2.31 |
| 14 | 6.19 | 209 | 8.42 | 105 | 1.36 | 0.502 | 10.45 | 234 | 104.5 | 2.34 |
| 15 | 7.68 | 215 | 9.22 | 106 | 1.20 | 0.494 | 12.00 | 239 | 120.1 | 2.40 |
| 16 | 8.10 | 209 | 9.24 | 104 | 1.14 | 0.496 | 12.29 | 234 | 123.0 | 2.34 |
| 17 | 6.19 | 210 | 8.46 | 106 | 1.37 | 0.502 | 10.48 | 236 | 104.9 | 2.36 |
| 18 | 7.40 | 210 | 9.00 | 103 | 1.22 | 0.494 | 11.70 | 234 | 116.6 | 2.34 |
| 19 | 8.54 | 215 | 9.71 | 105 | 1.14 | 0.486 | 12.9 | 240 | 129.5 | 2.40 |
| C20 | 4.2 | 199 | 7.01 | 105 | 1.67 | 0.528 | 8.17 | 225 | 81.8 | 2.26 |
| 21 | 5.1 | 197 | 7.40 | 103 | 1.45 | 0.523 | 8.98 | 222 | 89.8 | 2.22 |
| 22 | 5.9 | 200 | 7.91 | 103 | 1.34 | 0.515 | 9.87 | 225 | 98.7 | 2.25 |
| 23 | 4.9 | 190 | 7.11 | 100 | 1.45 | 0.526 | 8.65 | 215 | 86.6 | 2.15 |
| 24 | 5.8 | 195 | 7.62 | 101 | 1.31 | 0.518 | 9.55 | 220 | 95.6 | 2.20 |
| CD | 5.46 | 216 | 8.58 | 107 | 1.57 | 0.495 | 10.2 | 241 | 101.8 | 2.41 |
| CE | 5.87 | 217 | 9.07 | 103 | 1.55 | 0.475 | 10.8 | 240 | 108.2 | 2.40 |
| CF | 4.7 | 203 | 7.60 | 103 | 1.62 | 0.507 | 8.29 | 228 | 89.3 | 2.28 |

TABLE XIV
Rheological Properties at 190° C. (Carreau-
Yasuda Model) and Number of LCBs per 1,000,000
Total Carbon Atoms (Janzen and Colby Model).

| | η₀ | τ(η) | CY-a | LCB per Million |
|---|---|---|---|---|
| Example | (kPa-sec) | (sec) | parameter | Carbon Atoms |
| C13 | 377 | 2.9 | 0.297 | 2.7 |
| 14 | 732 | 5.9 | 0.265 | 3.6 |
| 15 | 1315 | 11.2 | 0.243 | 4.6 |
| 16 | 1723 | 15.6 | 0.232 | 5.9 |
| 17 | 712 | 5.7 | 0.267 | 3.4 |
| 18 | 1203 | 10.6 | 0.246 | 4.7 |
| 19 | 1748 | 16.1 | 0.237 | 5.9 |
| C20 | 336 | 2.5 | 0.295 | 2.5 |
| 21 | 537 | 4.2 | 0.268 | 4.3 |
| 22 | 744 | 6.0 | 0.256 | 5.8 |
| 23 | 525 | 4.2 | 0.266 | 4.4 |
| 24 | 779 | 6.3 | 0.249 | 5.6 |
| CD | 443 | 3.5 | 0.306 | 2.1 |
| CE | 445 | 3.8 | 0.321 | 2.4 |
| CF | 375 | 3.0 | 0.301 | 2.2 |

TABLE XV
Melt Strength at Draw Down Ratio
of 2.6 using RHEOTENS 71.97.

| | Melt Strength - Draw |
|---|---|
| Example | Down Ratio of 2.6 (N) |
| C13 | 0.454 |
| 14 | 0.508 |
| 15 | 0.528 |
| 16 | 0.538 |
| 17 | 0.483 |
| 18 | 0.503 |
| 19 | 0.518 |
| C20 | 0.434 |
| 21 | 0.447 |
| 22 | 0.455 |
| 23 | 0.446 |
| 24 | 0.453 |
| CD | 0.514 |
| CE | 0.443 |
| CF | 0.456 |

TABLE XVI
Thickness Variations for Blown Film Samples.

| | Gauge Variation | Gauge Variation | 2 Sigma | 2 Sigma |
|---|---|---|---|---|
| | by Range - | by Range - | CoV - 1.0 | CoV - 0.5 |
| Example | 1.0 mil (%) | 0.5 mil (%) | mil (%) | mil (%) |
| C13 | 43 | 32 | 18 | 24 |
| 14 | 35 | 29 | 12 | 22 |
| 15 | 32 | 19 | 11 | 16 |
| 16 | 32 | 23 | 11 | 12 |
| 17 | 37 | 31 | 13 | 20 |
| 18 | 32 | 24 | 11 | 16 |
| 19 | 29 | 22 | 9 | 16 |
| C20 | 81 | 126 | 34 | 42 |
| 21 | 81 | 114 | 30 | 34 |
| 22 | 59 | 55 | 24 | 20 |
| 23 | 88 | 89 | 24 | 26 |
| 24 | 62 | 56 | 23 | 18 |
| CD | 26 | 43 | 9 | 13 |
| CE | 28 | 33 | 13 | 11 |
| CF | 77 | 103 | 27 | 34 |

TABLE XVII
MD and TD Tear Strengths and Dart Drop
Impact Strength for Blown Film Samples.

| | Average | Average | Average | Average | Dart Drop | Dart Drop |
|---|---|---|---|---|---|---|
| | MD - | MD - | TD - | TD - | Impact - | Impact - |
| | 1.0 mil | 0.5 mil | 1.0 mil | 0.5 mil | 1.0 mil | 0.5 mil |
| Example | (g/mil) | (g/mil) | (g/mil) | (g/mil) | (g) | (g) |
| C13 | 42.6 | — | 375 | 318 | 304 | 80 |
| 14 | 61.0 | — | 362 | 288 | 276 | 100 |
| 15 | 50.9 | — | 290 | 271 | 252 | 102 |
| 16 | 68.8 | — | 290 | 279 | 222 | 91 |
| 17 | 50.7 | — | 288 | 314 | 260 | 98 |
| 18 | 47.8 | — | 314 | 288 | 238 | 100 |
| 19 | 50.2 | — | 275 | 230 | 236 | 98 |
| C20 | 22.6 | 15.4 | 446 | 543 | 242 | 138 |
| 21 | 26.5 | 18.7 | 349 | 403 | 236 | 176 |
| 22 | 33.2 | 23.9 | 263 | 359 | 244 | 162 |
| 23 | 25.4 | 18.0 | 385 | 467 | 222 | 128 |
| 24 | 30.9 | 19.5 | 315 | 456 | 222 | 118 |
| CD | 24.0 | 10.4 | 223 | 409 | 242 | 78 |
| CE | 24.9 | 11.1 | 206 | 316 | 240 | 112 |
| CF | 23.4 | 13.7 | 486 | 494 | 322 | 204 |

TABLE XVIII
Tensile Properties for 1-mil Thick Blown Film Samples.

| | | | | MD | | TD |
|---|---|---|---|---|---|---|
| | MD 1% | TD 1% | MD | Tensile | TD | Tensile |
| | Secant | Secant | Strain | Strength | Strain | Strength |
| | Modulus | Modulus | at Break | at Break | at Break | at Break |
| Example | (psi) | (psi) | (%) | (psi) | (%) | (psi) |
| C13 | — | — | 395 | 9,120 | 491 | 7,369 |
| 14 | — | — | 402 | 9,288 | 489 | 7,759 |
| 15 | — | — | 399 | 8,847 | 482 | 7,686 |
| 16 | — | — | 427 | 9,259 | 512 | 7,308 |
| 17 | — | — | 400 | 9,603 | 491 | 8,312 |
| 18 | — | — | 412 | 9,393 | 496 | 7,204 |
| 19 | — | — | 407 | 8,648 | 479 | 6,903 |
| C20 | 117,692 | 159,638 | 350 | 9,374 | 424 | 5,284 |
| 21 | 128,604 | 174,912 | 419 | 8,661 | 408 | 4,752 |
| 22 | 128,640 | 153,844 | 464 | 9,066 | 411 | 5,785 |
| 23 | 128,282 | 161,572 | 422 | 11,900 | 576 | 9,670 |
| 24 | 124,858 | 142,628 | 452 | 8,201 | 554 | 7,273 |
| CD | 123,040 | 150,834 | 418 | 9,378 | 500 | 6,952 |
| CE | 135,202 | 161,406 | 395 | 8,616 | 518 | 8,526 |
| CF | 120,444 | 165,898 | 305 | 8,423 | 418 | 6,193 |

TABLE XIX
Tensile Properties for 0.5-mil Thick Blown Film Samples.

| | | | | MD | | TD |
|---|---|---|---|---|---|---|
| | MD 1% | TD 1% | MD | Tensile | TD | Tensile |
| | Secant | Secant | Strain | Strength | Strain | Strength |
| | Modulus | Modulus | at Break | at Break | at Break | at Break |
| Example | (psi) | (psi) | (%) | (psi) | (%) | (psi) |
| C13 | — | — | 188 | 11,647 | 432 | 5,570 |
| 14 | — | — | 181 | 9,766 | 480 | 5,609 |
| 15 | — | — | 140 | 8,057 | 394 | 4,687 |
| 16 | — | — | 245 | 10,616 | 478 | 5,104 |
| 17 | — | — | 212 | 10,770 | 521 | 5,738 |
| 18 | — | — | 225 | 10,160 | 505 | 6,927 |
| 19 | — | — | 239 | 10,532 | 507 | 6,879 |
| C20 | 134,002 | 174,096 | 252 | 10,568 | 449 | 5,413 |
| 21 | 147,094 | 161,356 | 307 | 9,636 | 413 | 5,390 |
| 22 | 141,926 | 162,664 | 291 | 8,827 | 435 | 7,386 |
| 23 | 144,984 | 152,562 | 300 | 10,863 | 482 | 5,704 |
| 24 | 144,448 | 160,592 | 325 | 9,900 | 442 | 5,545 |
| CD | 149,458 | 191,796 | 211 | 9,568 | 493 | 6,003 |
| CE | 114,119 | 179,646 | 263 | 11,476 | 479 | 5,410 |
| CF | 140,660 | 159,342 | 227 | 12,002 | 437 | 7,663 |

TABLE XX
Gel Count Comparison.

| | Number of gels 200 μm to |
|---|---|
| Example | 800 μm (number per ft²) |
| C13 | 1.9 |
| 14 | 1.4 |
| 15 | 16.0 |
| 16 | 7.0 |
| 17 | 1.6 |
| 18 | 1.0 |
| 19 | 1.4 |
| C20 | 5.6 |
| 21 | 2.8 |
| 22 | 2.8 |
| 23 | 1.5 |
| 24 | 1.1 |
| CD | 63.5 |
| CE | 21.0 |
| CF | 5.6 |

The invention is described herein with reference to numerous aspects and specific examples. Many variations will suggest themselves to those skilled in the art in light of the detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A method for making an ethylene polymer with reduced film thickness variation, the method comprising melt processing a mixture (or blend) of a base polymer (or base resin) and a peroxide compound through a die to produce the ethylene polymer; wherein an amount of the peroxide compound is from 1 to 10 ppm by weight of peroxide groups based on a weight of the base polymer (or based on a weight of the ethylene polymer), and a film thickness variation of a blown film produced from the ethylene polymer is less than that of the base polymer.

Aspect 2. A method for reducing film thickness variation of a film, the method comprising (i) melt processing a mixture (or blend) of a base polymer (or base resin) and a peroxide compound through a die to produce an ethylene polymer, and (ii) melt processing the ethylene polymer through a film die to produce the film; wherein an amount of the peroxide compound is from 1 to 10 ppm by weight of peroxide groups based on a weight of the base polymer (or based on a weight of the ethylene polymer); and a film thickness variation of the film produced from the ethylene polymer is less than that of the base polymer, under the same film processing conditions.

Aspect 3. The method defined in aspect 1 or 2, wherein the base polymer is in the form of fluff or powder.

Aspect 4. The method defined in any one of aspects 1-3, wherein the ethylene polymer is in the form or pellets or beads.

Aspect 5. The method defined in any one of aspects 1-4, wherein the melt processing of the mixture is performed at any suitable melt processing temperature, e.g., from 130 to 400° C., from 150 to 300° C., or from 175 to 275° C.

Aspect 6. The method defined in any one of aspects 1-5, wherein the melt processing of the mixture comprises extrusion.

Aspect 7. The method defined in any one of aspects 1-6, wherein the melt processing of the mixture is performed in a twin screw extrusion system.

Aspect 8. The method defined in any one of aspects 1-7, wherein the die is a pelletizing die or a strand die.

Aspect 9. The method defined in any one of aspects 1-8, wherein the amount of the peroxide compound is any suitable ppm amount of the peroxide groups based on the weight of the base polymer (or the weight of the ethylene polymer), e.g., from 1 to 8 ppm, from 1 to 7 ppm, from 2 to 8, from 2 to 7 ppm, or from 2 to 6 ppm.

Aspect 10. The method defined in any one of aspects 1-9, wherein the peroxide compound comprises any suitable peroxide compound, e.g., 2,5-dimethyl-2,5-di(t-butylperoxy) hexane, dicumyl peroxide, t-butyl cumyl peroxide, n-butyl-4,4′-di(t-butylperoxy) valerate, 2,5-dimethyl-2,5-di(tert-butylperoxy) hexyne-3, or any combination thereof.

Aspect 11. The method defined in any one of aspects 1-10, wherein the peroxide compound is present in a polymer masterbatch at any suitable loading, e.g., from 0.5 to 40 wt. %, from 10 to 75 wt. %, from 10 to 60 wt. %, from 10 to 50 wt. %, or from 15 to 40 wt. %, based on a total weight of the polymer masterbatch.

Aspect 12. The method defined in any one of aspects 1-10, wherein the peroxide compound is present in a (non-polymer) masterbatch at any suitable loading, e.g., from 0.5 to 50 wt. %, from 10 to 75 wt. %, from 25 to 60 wt. %, from 30 to 55 wt. %, or from 35 to 50 wt. %, based on a total weight of the masterbatch (which contains less than 8 wt. %, less than 5 wt. %, or less than 2 wt. % of a polyolefin).

Aspect 13. The method defined in any one of aspects 2-12, wherein the film die is a blown film die and the film is a blown film.

Aspect 14. The method defined in any one of aspects 2-12, wherein the film die is a cast film die and the film is a cast film.

Aspect 15. The method defined in any one of aspects 2-14, wherein the melt processing of the ethylene polymer is performed at any suitable melt processing temperature, e.g., from 150 to 400° C., from 150 to 300° C., or from 175 to 250° C.

Aspect 16. The method defined in any one of aspects 2-15, wherein the melt processing of the ethylene polymer comprises extrusion.

Aspect 17. The method defined in any one of aspects 2-16, wherein the melt processing of the ethylene polymer is performed in a single screw extrusion system.

Aspect 18. The method defined in any one of aspects 1-17, wherein the film (or the blown film) has any suitable average thickness, e.g., from 0.3 to 20 mils, from 0.3 to 5 mils, from 0.3 to 0.8 mils, from 0.4 to 2 mils, from 0.4 to 0.8 mils, from 0.5 to 2 mils, from 0.5 to 1.5 mils, or from 0.5 to 0.8 mils.

Aspect 19. The method defined in any one of aspects 1-18, wherein the film (or the blown film) produced from the ethylene polymer has a film thickness variation that is at least 5% less, at least 10% less, at least 20% less, at least 25% less, or at least 50% less, than that of the base polymer.

Aspect 20. The method defined in any one of aspects 1-19, wherein the film (or the blown film) produced from the ethylene polymer has a film thickness variation (2 sigma coefficient of variation) in any suitable range, e.g., from 5% to 35%, from 10% to 35%, 5% to 25%, from 10% to 25%, from 10% to 22%, from 5% to 20%, from 10% to 18%, from 5% to 15%, or from 5% to 12%.

Aspect 21. The method defined in any one of aspects 1-20, wherein the base polymer (or the ethylene polymer) is a Ziegler-Natta based polymer (produced using a Ziegler-Natta catalyst).

Aspect 22. The method defined in any one of aspects 1-21, wherein the base polymer (or the ethylene polymer) has a bimodal molecular weight distribution.

Aspect 23. The method defined in any one of aspects 1-22, wherein the base polymer (or the ethylene polymer) comprises an ethylene homopolymer and/or an ethylene/α-olefin copolymer.

Aspect 24. The method defined in any one of aspects 1-23, wherein the base polymer (or the ethylene polymer) comprises an ethylene homopolymer, an ethylene/1-butene copolymer, an ethylene/1-hexene copolymer, and/or an ethylene/1-octene copolymer.

Aspect 25. The method defined in any one of aspects 1-24, wherein the base polymer (or the ethylene polymer) comprises an ethylene/1-hexene copolymer.

Aspect 26. The method defined in any one of aspects 1-25, wherein the base polymer (or the ethylene polymer) comprises an additive selected from an antiblock additive, a slip additive, a phenolic antioxidant, a phosphite antioxidant, a colorant, a filler, a UV additive, an anti-stat additive, a processing aid, an acid scavenger, or any combination thereof.

Aspect 27. The method defined in any one of aspects 1-26, wherein the base polymer (or the ethylene polymer) contains an amount (in ppm by weight) of zirconium (or hafnium, or chromium, independently), in any suitable range, e.g., less than 0.2 ppm, less than 0.1 ppm, less than 0.08 ppm, less than 0.05 ppm, or less than 0.03 ppm, of zirconium (or hafnium, or chromium, independently).

Aspect 28. The method defined in any one of aspects 1-27, wherein the base polymer (or the ethylene polymer) contains an amount (in ppm by weight) of titanium in any suitable range, e.g., from 0.5 ppm to 15 ppm, from 0.5 ppm to 10 ppm, from 1 ppm to 15 ppm, or from 1 ppm to 10 ppm, of titanium.

Aspect 29. The method defined in any one of aspects 1-28, wherein the base polymer has a high load melt index (HLMI) in a range from 4 to 15 g/10 min and a density in a range from 0.94 to 0.96 g/cm³, and one or more of the following properties: a zero-shear viscosity (η₀) in a range from 300 to less than 450 kPa-s; a relaxation time (Tau(eta) or τ(η)) in a range from 2 to less than 4 sec; a CY-a parameter in a range from greater than 0.28 to 0.33; a tan δ at 0.1 sec⁻¹ in a range from greater than 1.5 to 1.75 degrees; and/or from 1.5 to less than 3 long chain branches (LCBs) per 1,000,000 total carbon atoms.

Aspect 30. The method defined in aspect 29, wherein the base polymer is further characterized by a ratio of Mw/Mn of from 20 to 40, a Mw of from 200,000 to 325,000 g/mol, and a Mp from 90,000 to 200,000 g/mol.

Aspect 31. An ethylene polymer having (or characterized by) a high load melt index (HLMI) in a range from 4 to 15 g/10 min, a density in a range from 0.94 to 0.96 g/cm³, and a zero-shear viscosity (η₀) in a range from 475 to 2000 kPa-s.

Aspect 32. An ethylene polymer having (or characterized by) a high load melt index (HLMI) in a range from 4 to 15 g/10 min, a density in a range from 0.94 to 0.96 g/cm³, and a relaxation time (Tau(eta) or τ(η)) in a range from 4 to 20 sec.

Aspect 33. An ethylene polymer having (or characterized by) a high load melt index (HLMI) in a range from 4 to 15 g/10 min, a density in a range from 0.94 to 0.96 g/cm³, and a CY-a parameter in a range from 0.2 to 0.28.

Aspect 34. An ethylene polymer having (or characterized by) a high load melt index (HLMI) in a range from 4 to 15 g/10 min, a density in a range from 0.94 to 0.96 g/cm³, and a tan δ at 0.1 sec⁻¹ in a range from 1 to 1.5 degrees.

Aspect 35. An ethylene polymer having (or characterized by) a high load melt index (HLMI) in a range from 4 to 15 g/10 min, a density in a range from 0.94 to 0.96 g/cm³, and from 3 to 10 long chain branches (LCBs) per 1,000,000 total carbon atoms.

Aspect 36. The polymer defined in any one of aspects 31-35, wherein the HLMI is in any suitable range, e.g., from 4 to 12, from 4 to 10, from 5 to 15, from 5 to 12, from 5 to 10, from 6 to 12, from 7 to 15, from 7 to 12, from 7 to 11, from 7 to 10, or from 8 to 10 g/10 min.

Aspect 37. The polymer defined in any one of aspects 31-36, wherein the density is in any suitable range, e.g., from 0.942 to 0.96, from 0.945 to 0.96, from 0.945 to 0.956, from 0.945 to 0.952, from 0.948 to 0.96, from 0.948 to 0.958, from 0.948 to 0.954, or from 0.948 to 0.952 g/cm³.

Aspect 38. The polymer defined in any one of aspects 31-37, wherein the ethylene polymer has a zero-shear viscosity (η₀) in any suitable range, e.g., from 475 to 2000, from 475 to 1200, from 475 to 1000, from 500 to 2000, from 500 to 1200, from 500 to 1100, from 500 to 1000, from 550 to 2000, from 550 to 1200, or from 550 to 1100 kPa-s.

Aspect 39. The polymer defined in any one of aspects 31-38, wherein the ethylene polymer has a relaxation time (Tau(eta) or τ(η)) in any suitable range, e.g., from 4 to 20, from 4 to 15 sec, from 4 to 12 sec, from 4 to 10 sec, from 4.25 to 20 sec, from 4.25 to 15 sec, from 4.25 to 12 sec, from 4.25 to 10 sec, from 4.5 to 20 sec, from 4.5 to 15 sec, from 4.5 to 12 sec, from 4.5 to 10 sec, or from 4.5 to 9 sec

Aspect 40. The polymer defined in any one of aspects 31-39, wherein the ethylene polymer has a CY-a parameter in any suitable range, e.g., from 0.2 to 0.28, from 0.2 to 0.275, from 0.22 to 0.28, from 0.22 to 0.275, from 0.24 to 0.28, or from 0.24 to 0.275.

Aspect 41. The polymer defined in any one of aspects 31-40, wherein the ethylene polymer has a tan δ (tan d or tangent delta) at 0.1 sec⁻¹ in any suitable range, e.g., from 1 to 1.5, from 1 to 1.45, from 1.05 to 1.5, from 1.05 to 1.45, from 1.1 to 1.5, from 1.1 to 1.45, from 1.2 to 1.5, or from 1.2 to 1.45 degrees.

Aspect 42. The polymer defined in any one of aspects 31-41, wherein the ethylene polymer has from 3 to 10, from 3 to 9, from 3 to 8, from 3 to 7, or from 3 to 6 long chain branches (LCBs) per 1,000,000 total carbon atoms.

Aspect 43. The polymer defined in any one of aspects 31-42, wherein the ethylene polymer contains less than or equal to 50 ppm, less than or equal to 45 ppm, less than or equal to 40 ppm, less than or equal to 25 ppm, or less than or equal to 10 ppm (by weight) of calcium.

Aspect 44. The polymer defined in any one of aspects 31-43, wherein the ethylene polymer has less than or equal to 20, less than or equal to 15, less than or equal to 12, less than or equal to 10 gels/ft², or less than or equal to 8 gels/ft².

Aspect 45. The polymer defined in any one of aspects 31-44, wherein the ethylene polymer has a ratio of Mw/Mn in any suitable range, e.g., from 20 to 40, from 20 to 38, from 20 to 35, from 20 to 32, from 22 to 40, from 22 to 36, from 22 to 32, from 24 to 40, from 24 to 38, from 24 to 34, from 26 to 38, from 26 to 36, or from 26 to 34.

Aspect 46. The polymer defined in any one of aspects 31-45, wherein the ethylene polymer has a Mw in any suitable range, e.g., from 200,000 to 325,000, from 200,000 to 300,000, from 200,000 to 275,000, from 225,000 to 325,000, from 225,000 to 300,000, or from 225,000 to 275,000 g/mol.

Aspect 47. The polymer defined in any one of aspects 31-46, wherein the ethylene polymer has a Mp in any suitable range, e.g., from 90,000 to 200,000, from 100,000 to 190,000, from 100,000 to 170,000, from 100,000 to 150,000, from 110,000 to 190,000, from 110,000 to 170,000, or from 110,000 to 150,000 g/mol.

Aspect 48. The polymer defined in any one of aspects 31-47, wherein the ethylene polymer has a bimodal molecular weight distribution.

Aspect 49. The polymer defined in any one of aspects 31-48, wherein the ethylene polymer comprises an ethylene homopolymer and/or an ethylene/α-olefin copolymer.

Aspect 50. The polymer defined in any one of aspects 31-49, wherein the ethylene polymer comprises an ethylene homopolymer, an ethylene/1-butene copolymer, an ethylene/1-hexene copolymer, and/or an ethylene/1-octene copolymer.

Aspect 51. The polymer defined any one of aspects 31-50, wherein the ethylene polymer comprises an ethylene/1-hexene copolymer.

Aspect 52. The polymer defined in any one of aspects 31-51, wherein the ethylene polymer comprises an additive selected from an antiblock additive, a slip additive, a phenolic antioxidant, a phosphite antioxidant, a colorant, a filler, a UV additive, an anti-stat additive, a processing aid, an acid scavenger, or any combination thereof.

Aspect 53. The polymer defined in any one of aspects 31-52, wherein the ethylene polymer contains, independently, less than 0.1 ppm (by weight), less than 0.08 ppm, less than 0.05 ppm, or less than 0.03 ppm, of zirconium (or hafnium, or chromium, independently).

Aspect 54. The polymer defined in any one of aspects 31-53, wherein the ethylene polymer contains an amount (in ppm by weight) of titanium in any suitable range, e.g., from 0.5 ppm to 15 ppm, from 0.5 ppm to 10 ppm, from 1 ppm to 15 ppm, or from 1 ppm to 10 ppm, of titanium.

Aspect 55. An article comprising the ethylene polymer defined in any one of aspects 31-54.

Aspect 56. An article comprising the ethylene polymer defined in any one of aspects 31-54, wherein the article is an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier.

Aspect 57. An article comprising the ethylene polymer defined in any one of aspects 31-54, wherein the article is a (monolayer or multilayer) blown film or cast film.

Aspect 58. A (monolayer or multilayer) blown film comprising the ethylene polymer defined in any one of aspects 31-54.

Aspect 59. The film defined in aspect 58, wherein the blown film has any suitable average thickness, e.g., from 0.3 to 20 mils, from 0.3 to 5 mils, from 0.3 to 0.8 mils, from 0.4 to 2 mils, from 0.4 to 0.8 mils, from 0.5 to 2 mils, from 0.5 to 1.5 mils, or from 0.5 to 0.8 mils.

Aspect 60. The film defined in aspect 58 or 59, wherein the blown film has a film thickness variation (2 sigma coefficient of variation) in any suitable range, e.g., from 5% to 35%, from 10% to 35%, from 5% to 25%, from 10% to 25%, from 10% to 22%, from 5% to 20%, from 10% to 18%, from 5% to 15%, or from 5% to 12%.

Aspect 61. The film defined in any one of aspects 58-60, wherein the film has a dart impact strength in any suitable range, e.g., from 50 to 500, from 100 to 500, from 100 to 400, from 100 to 300, from 150 to 400, from 150 to 300, or from 200 to 300 g/mil.

Aspect 62. The film defined in any one of aspects 58-61, wherein the film has a MD Elmendorf tear strength in any suitable range, e.g., from 5 to 100, from 5 to 70, from 5 to 60, from 5 to 40, from 10 to 100, from 10 to 70, or from 10 to 40 g/mil.

Aspect 63. The film defined in any one of aspects 58-62, wherein the film has a TD Elmendorf tear strength in any suitable range, e.g., from 150 to 1000, from 150 to 800, from 150 to 500, from 200 to 1000, from 200 to 800, or from 200 to 500 g/mil.

What is claimed is:

1. An ethylene polymer having (or characterized by):
a high load melt index (HLMI) in a range from 4 to 15 g/10 min;
a density in a range from 0.94 to 0.96 g/cm³; and
at least one of:
a CY-a parameter in a range from 0.2 to 0.28; and/or
a tan δ at 0.1 sec⁻¹ in a range from 1 to 1.5 degrees; and/or
from 3 to 10 long chain branches (LCBs) per 1,000,000 total carbon atoms.

2. The polymer of claim 1, wherein the ethylene polymer is characterized by two of:
the CY-a parameter in a range from 0.2 to 0.28; and/or
the tan δ at 0.1 sec⁻¹ in a range from 1 to 1.5 degrees; and/or
from 3 to 10 long chain branches (LCBs) per 1,000,000 total carbon atoms.

3. The polymer of claim 1, wherein the ethylene polymer is characterized by:
the CY-a parameter in a range from 0.2 to 0.28;
the tan δ at 0.1 sec⁻¹ in a range from 1 to 1.5 degrees; and
from 3 to 10 long chain branches (LCBs) per 1,000,000 total carbon atoms.

4. The polymer of claim 1, wherein ethylene polymer is further characterized by a zero-shear viscosity (η₀) in a range from 475 to 2000 kPa-s.

5. The polymer of claim 1, wherein ethylene polymer is further characterized by a relaxation time (Tau(eta) or τ(η)) in a range from 4 to 20 sec.

6. The polymer of claim 1, wherein the ethylene polymer is further characterized by:
a ratio of Mw/Mn in a range from 20 to 40;
a Mw in a range from 200,000 to 325,000 g/mol;
a Mp in a range from 90,000 to 200,000 g/mol; or
any combination thereof.

7. The polymer of claim 1, wherein the ethylene polymer is further characterized by:
a ratio of Mw/Mn in a range from 22 to 36;
a Mw in a range from 225,000 to 300,000 g/mol;
a Mp in a range from 100,000 to 170,000 g/mol; or
any combination thereof.

8. The polymer of claim 1, wherein the ethylene polymer contains less than or equal to 50 ppm (by weight) of calcium.

9. The polymer of claim 1, wherein the ethylene polymer is further characterized by a gel count of less than or equal to 20 gels/ft², wherein the gels have a size in diameter of 200-800 microns in a 50 micron thick film.

10. The polymer of claim 1, wherein the HLMI is in a range from 7 to 11 g/10 min.

11. The polymer of claim 1, wherein the ethylene polymer comprises an ethylene homopolymer, an ethylene/1-butene copolymer, an ethylene/1-hexene copolymer, and/or an ethylene/1-octene copolymer.

12. The polymer of claim 1, wherein the ethylene polymer contains, independently, less than 0.1 ppm by weight of zirconium, hafnium, and chromium.

13. An article of manufacture comprising the ethylene polymer of claim 1.

14. A blown film comprising the ethylene polymer of claim 1.

15. The blown film of claim 14, wherein the blown film has:
an average thickness in a range from 0.3 to 20 mils;
a film thickness variation (2 sigma coefficient of variation) in a range from 5% to 35%;
a dart impact strength in a range from 100 to 500 g/mil;
a MD Elmendorf tear strength in a range from 5 to 100 g/mil;
a TD Elmendorf tear strength in a range from 150 to 1000 g/mil; or
any combination thereof.

16. A method for making an ethylene polymer with reduced film thickness variation, the method comprising:
melt processing a mixture of a base polymer and a peroxide compound through a die to produce the ethylene polymer; wherein:
an amount of the peroxide compound is from 1 to 10 ppm by weight of peroxide groups based on a weight of the base polymer (or based on a weight of the ethylene polymer); and
a film thickness variation of a blown film produced from the ethylene polymer is less than that of the base polymer.

17. The method of claim 16, wherein the base polymer is a Ziegler-Natta based polymer (produced using a Ziegler-Natta catalyst).

18. The method of claim 16, wherein the blown film produced from the ethylene polymer has a film thickness variation that is at least 5% less than that of the base polymer.

19. A method for reducing film thickness variation of a film, the method comprising:
(i) melt processing a mixture of a base polymer and a peroxide compound through a die to produce an ethylene polymer; and
(ii) melt processing the ethylene polymer through a film die to produce the film; wherein:
an amount of the peroxide compound is from 1 to 10 ppm by weight of peroxide groups based on a weight of the base polymer (or based on a weight of the ethylene polymer); and
a film thickness variation of the film produced from the ethylene polymer is less than that of the base polymer, under the same film processing conditions.

20. The method of claim 19, wherein:
the base polymer is a Ziegler-Natta based polymer (produced using a Ziegler-Natta catalyst); and
the film produced from the ethylene polymer has a film thickness variation that is at least 5% less than that of the base polymer.
